(19) United States
(12) Patent Application Publication
(10) Pub. No.: US 2013/0184973 A1
(43) Pub. Date: Jul. 18, 2013

(54) FUEL INJECTION AMOUNT CONTROL APPARATUS FOR AN INTERNAL COMBUSTION ENGINE

(71) Applicants: Shuntaro Okazaki, Sunto-gun (JP); Masashi Shibayama, Sunto-gun (JP)

(72) Inventors: Shuntaro Okazaki, Sunto-gun (JP); Masashi Shibayama, Sunto-gun (JP)

(73) Assignee: TOYOTA JIDOSHA KABUSHIKI KAISHA, Toyota-shi, Aichi (JP)

(21) Appl. No.: 13/812,415

(22) PCT Filed: Jul. 27, 2010
(86) PCT No.: PCT/JP2010/062990

§ 371 Date: Apr. 1, 2013

(51) Int. Cl. F02D 41/30

(52) U.S. Cl. CPC F02D 41/30
USPC 701/104

(57) ABSTRACT

A fuel injection amount control apparatus disclosed in the present specification calculates a time integral value SDVoxslow by accumulating values each obtained by multiplying a deviation DVoxslow between an output value Voxs of a downstream air-fuel ratio sensor disposed downstream of a catalyst and a predetermined downstream target value Voxsref by a predetermined adjusting gain K (step 1140), and stores it as a sub FB learning value KSFBg (step 1165). The apparatus sets different values from each other in the adjusting gain K when the sub FB learning value is increasing and in the adjusting gain K when the sub FB learning value is decreasing, in such a manner that an absolute value of a difference between a magnitude of an increasing speed of the sub FB learning value and a magnitude of a decreasing speed of the FB learning value becomes smaller (step 1125 through step 1135). The control apparatus determines that the sub FB learning value has converged when the sub FB learning value is present between an upper limit value and a lower limit value over a predetermined time period, the upper limit value being a value obtained by adding a specific value to a determination reference value corresponding to a variation center of the sub FB learning value, and the lower limit value being a value obtained by subtracting a specific value from the determination reference value.

### TECHNICAL FIELD

The present invention relates to a fuel injection amount control apparatus for an internal combustion engine, which controls a fuel injection amount based on an output value of an air-fuel ratio sensor (a downstream air-fuel ratio sensor) disposed downstream of a catalyst which is disposed in an exhaust gas passage of the internal combustion engine.

### BACKGROUND ART

As shown in FIG. 1, one of conventional fuel injection amount control apparatuses (hereinafter, referred to as a “conventional apparatus”) for an internal combustion engine comprises a catalyst (a three-way catalyst) 43 disposed in an exhaust gas passage of the engine, an upstream air-fuel ratio sensor 56, and a downstream air-fuel ratio sensor 57. The upstream air-fuel ratio sensor 56 and the downstream air-fuel ratio sensor 57 are disposed upstream and downstream, respectively, of the catalyst 43. An output value Vabyfs of the upstream air-fuel ratio sensor 56 changes with respect to the air-fuel ratio (an upstream air-fuel ratio abyfs) of a gas to be detected as shown in FIG. 2. An output value Voxs of the downstream air-fuel ratio sensor 57 changes with respect to the air-fuel ratio (a downstream air-fuel ratio afdown) of a gas to be detected as shown in FIG. 3.

The conventional apparatus calculates a “correction amount of fuel injection amount” for making an air-fuel ratio (an upstream air-full ratio abyfs) represented by the output value of the upstream air-fuel ratio sensor coincide with a “target air-fuel ratio which is set to (at) a stoichiometric air-fuel ratio.” This correction amount is also referred to as a main feedback amount. Further, the conventional apparatus performs an integral process on a value based on a “difference between the output value of the downstream air-fuel ratio sensor and a downstream target value which is set to (at) a value corresponding to the stoichiometric air-fuel ratio.” The conventional apparatus calculates an integral term of “the correction amount of the fuel injection amount” based on the integral-processed value (hereinafter, also referred to as a “time integral value”), and, then, calculates the “correction amount of the fuel injection amount” including this integral term. This correction amount is also referred to as a sub feedback amount. Thereafter, the conventional apparatus corrects the fuel injection amount using these correction amounts (the main feedback amount and the sub feedback amount) to control the air-fuel ratio of an air-fuel mixture supplied to the engine in such a manner that the air-fuel ratio of the air-fuel mixture coincides with the stoichiometric air-fuel ratio. Note that the air-fuel ratio of the air-fuel mixture supplied to the engine is also referred to as an air-fuel ratio of the engine, and is substantially the same as an air-fuel ratio of an exhaust gas flowing into the catalyst 43.

A detection error of the intake air amount of an airflow meter, an individual difference and a change in time in injection characteristics of fuel injection valves, and a detection error of the air-fuel ratio of the upstream air-fuel ratio sensor (hereinafter, generally referred to as an “error of an intake air and exhaust gas system”) causes a steady error of the air-fuel ratio of the engine with respect to a target air-fuel ratio. Therefore, the error of the intake air and exhaust gas system appears in the above-mentioned time integral value. That is, the above-mentioned time integral value is converged into a value equal to a value representing a magnitude of the error of the intake air and exhaust gas system. Accordingly, the conventional apparatus can have/make the air-fuel ratio of the engine substantially coincide with the stoichiometric air-fuel ratio, even when the error of the intake air and exhaust gas system occurs.

However, it takes a certain time period for the time integral value to converge. Further, during a “time period in which a sub feedback control condition is not satisfied (e.g., time period in which the downstream air-fuel ratio sensor is not activated)”, the above-mentioned integral process is not carried out. In view of the above, the conventional apparatus memorizes and stores the above-mentioned time integral value (or a value correlated to the above-mentioned time integral value) as a learning value (a learning value of the sub feedback amount, or a sub FB learning value) in a “backup RAM or the like which can hold data even when the engine is not operating.” Further, the conventional apparatus controls the fuel injection amount using that learning value while the sub feedback condition is not satisfied, and uses a value corresponding to the learning value as an initial value of the time integral value when the sub feedback condition becomes satisfied.

Meanwhile, the above-mentioned learning value (or the time integral value) may greatly deviate from a value into which the learning value is supposed to converge (i.e., a value representing the magnitude of the error of the intake air and exhaust gas system, and hereinafter, referred to as a “convergent value”). For example, when the learning value stored in the backup RAM is cleared by exchanging battery or the like, the learning value may greatly deviate from the convergent value. Alternatively, the learning value may also greatly deviate from the convergent value, when a misfiring rate of the engine is changed, when the fuel injection characteristics of a fuel injection valve of a specific cylinder greatly deviates from those of fuel injection valves of the other cylinders, and the like.

In view of the above, in order to rapidly make the learning value (or the time integral value) converge into the convergent value, the conventional apparatus changes a “changing speed (rate) of the time integral value” in accordance with a degree of convergence of the learning value. More specifically, when a fluctuation amount of the learning value over a predetermined time period goes beyond a predetermined width, the conventional apparatus determines that the learning value has not converged to increase a single-time update amount of the time integral value, whereas, when the fluctuation amount of the learning value over the predetermined time period does not go beyond the predetermined width, the conventional apparatus determines that the learning value has converged to decrease the single-time update amount of the time integral value. Thus, it is possible to have the learning value rapidly come closer to the converged value when the learning value has not converged, and is possible to avoid that the learning value excessively fluctuates due to an external disturbance when the learning value has converged (for example, refer to Patent Literature 1).

### CITATION LIST

### Patent Literature

Patent Literature 1: Japanese Patent Application Laid-Open (Kokai) No. 2009-162139

### SUMMARY OF THE INVENTION

Incidentally, for the purpose of optimizing the purifying efficiency of the three-way catalyst 43 and/or reducing a discharge amount of a specific component (for example, NOx), the downstream target value may be set to (at) a “definite value other than a value Vst corresponding to the stoichiometric air-fuel ratio”, or may be changed based on “a state of the three-way catalyst 43, a operating state of the engine (e.g., an intake air amount), and the like.”

As a result, as shown in FIG. 4, in a case in which the downstream target value Voxsref is set at a value higher than the value Vst corresponding to the stoichiometric air-fuel ratio, a “magnitude dV1 of the changing speed (decreasing speed) of the time integral value SDVoxs (learning value) when the output value Voxs is larger than the downstream target value Voxsref (i.e., in a rich determination period)” is smaller than a “magnitude dV2 of the changing speed (increasing speed) of the time integral value SDVoxs (learning value) when the output value Voxs is smaller than the downstream target value Voxsref (in a lean determination period)”. This is considered to occur due to the following reasons.

(1) The time integral value SDVoxs is obtained by accumulating a value (K·DVoxs) which is in proportion to a “difference (output deviation amount DVoxs) between the output value Voxs and the downstream target value Voxsref” every elapse of a predetermined time period.

(2) Since a magnitude DR of the output deviation amount DVoxs in a rich determination period is smaller than a magnitude DL of the output deviation amount DVoxs in a lean determination period, the magnitude of a single-time update amount of the time integral value SDVoxs in a rich determination period is smaller than the magnitude of a single-time update amount of the time integral value SDVoxs in a lean determination period.

Note that, since the magnitude DR is smaller than the magnitude DL, a rich determination time duration TR is generally longer than a lean determination time duration TL.

On the one hand, a time period required to determine whether or not the learning value (or the time integral value) has converged is shorter when (by) “obtaining a deviation center (also referred to as a “determination reference value Vkijun”) of the learning value is calculated based on the past learning values (last values immediately before the current learning value), and determining whether or not a difference between the determination reference value Vkijun and the learning value in a predetermined time period is equal to or longer than a predetermined threshold value ΔV (specific values ΔV)” than when (by) “determining whether or not a fluctuation amount of the learning value over a predetermined time period has gone beyond a predetermined width” as in the conventional apparatus. This reason will next be explained with reference to FIG. 5.

As shown in (A) of FIG. 5, when the learning value (or the time integral value) sinusoidally changes, in order to determine whether the learning value has converged by determining “whether or not the fluctuation amount of the learning value over the predetermined time period has gone beyond the predetermined width”, the predetermined time period has to be at least “one period (cycle) T” or longer. This is because one period T is required to obtain a maximum value (a local maximum value) and a minimum value (a local minimum value) of the learning value.

In contrast, when determining whether or not the learning value has converged by determining “whether or not the difference between the above-mentioned determination reference value Vkijun and the latest learning value” is equal to or larger than the threshold value ΔV″, a time period for this determination is about a half period T/2. This is because any one of the maximum value (local maximum value) and a minimum value (local minimum value) of the learning value appears within an elapse of the half period T/2.

Therefore, in order to determine whether or not the learning value has converged, determining “whether or not the difference between the determination reference value Vkijun and the learning value over the predetermined time period is equal to or larger than the threshold value ΔV” is advantageous in view of shortening the determination time period.

However, as described above, for example, if the downstream target value Voxsref is set at the value higher than the value Vst corresponding to the stoichiometric air-fuel ratio, the “magnitude dV2 of the increasing speed of the learning value in the lean determination period” is larger than the “magnitude dV1 of the decreasing speed of the learning value in the rich determination period.” Therefore, even if the learning value has converged, there is a high possibility, when an external disturbance occurs, that the difference between the determination reference value Vkijun and the latest learning value is equal to or larger than the predetermined threshold value ΔV (see: timing t1 of FIG. 5(B)). In order to cope with this, if the threshold value ΔV is set at a relatively large value, it is erroneously determined that the learning value has converged even when the learning value has greatly decreased when the learning value has not actually converged (or the learning value has deviated from the convergent value).

Accordingly, an object of the present invention is to provide a “fuel injection amount control apparatus for an internal combustion engine” which can rapidly and precisely determine whether or not the learning value has converged, so as to set the changing speed of the learning value at an approximate value, and thus, to be capable of rapidly converging the learning value and to stably maintaining the learning value in the vicinity of the convergent value.”

One aspect of the fuel injection amount control apparatus for an internal combustion engine according to the present invention comprises: a fuel injection valve for injecting fuel into the engine; a downstream air-fuel ratio sensor, disposed downstream of a catalyst which is disposed in an exhaust gas passage of the engine, and outputting an output value corresponding to an air-fuel ratio of a gas flowing out from the catalyst; a correction amount calculating section; a learning section; and a fuel injection controlling section.

The correction amount calculating section calculates a time integral value by accumulating/integrating values, each obtained by multiplying a deviation/error between an output value of a downstream air-fuel ratio sensor and a predetermined downstream target value by a predetermined adjusting gain, in a period in which a predetermined downstream feedback condition is satisfied. Further, the correction amount calculating section calculates, based on “the calculated time integral value”, an “integral term” included in a “correction amount for feedback-correcting an amount of fuel injected from the fuel injection valve so as to have the output value of the downstream air-fuel ratio sensor coincide with the downstream target air-fuel ratio”, and calculating the correction amount based on the integral term.

The learning section obtains a value correlated (relevant) to the calculated integral term, as a learning value. That is, the learning section may obtain the time integral value as the learning value, or obtain the integral term as the learning value.

The fuel injection controlling section calculates a final fuel injection amount based on at least the correction amount when the downstream feedback condition is satisfied, calculates the final fuel injection amount based on at least the learning value when the downstream feedback condition is not satisfied, and injects fuel of the calculated final fuel injection amount from the fuel injection valve.

Further, the learning section is configured so as to determine that the learning value has converged when the learning value is (present) between an upper limit value and a lower limit value over a predetermined time period, the upper limit value being a value obtained by adding a positive specific value (a threshold value ΔV) to a “determination reference value, which is a variation center of past values of the learning value, and which is calculated based on the past values of the learning value”, and the lower limit value being a value obtained by subtracting the specific value from the determination reference value.

It can be said that the learning section is configured so as to determine that the learning value has converged when the magnitude of the difference between the determination reference value and the latest (current) value of the learning value is smaller than a predetermined threshold value (the specific value) over a predetermined determination time period. In other words, the learning section determines the learning value has not converged when the magnitude of the difference between the determination reference value and the latest value of the learning value becomes larger than the threshold value.

The correction amount calculating section is configured to set different values from each other between the “adjusting gain in a case in which the learning value is increasing (the time integral value is increasing)” and the “adjusting gain in a case in which the learning value is decreasing (the time integral value is decreasing)”, in such a manner that an absolute value of a difference between a magnitude of an increasing speed of the learning value and a magnitude of a decreasing speed of the learning value becomes smaller.

According to this configuration, the “magnitude of the changing speed of the learning value in the lean determination period” and the “magnitude of the changing speed of the learning value in the rich determination period” can be made to come closer to each other. Therefore, when the learning value has converged, the learning value is present “between the upper limit value and the lower limit value.” As a result, it can be determined with high accuracy that the learning value has converged.

In addition, according to the above-mentioned configuration, the determination of whether or not the learning value has converged can be carried out in a shorter time period, as compared with the determination of whether or not the magnitude of the variation of the learning value in a predetermined time period exceeds a threshold value, since the above-mentioned configuration determines whether or not the magnitude of the deviation of the learning value from the determination reference value in the predetermined time period exceeds the specific value.

Further, it is unnecessary to set the specific value at an excessively large value, and thus, it can be avoided that the learning value is erroneously determined to have converged when the learning value has not converged.

In this case, the learning section is preferably configured to set the adjusting gain in the case in which it is not determined that the learning value has converged at a value larger than the adjusting gain in the case in which it is determined that the learning value has converged.

According to this configuration, since the adjusting gain is set at a large value when the learning value has not converged, it is possible to have the learning value rapidly come closer to the convergent value. Note that, it is preferable that the adjusting gain in the case in which the learning value is increasing and the adjusting gain in the case in which the learning value is decreasing be set to values different from each other, when the learning value has not converged, as well.

A fuel injection amount control apparatus for an internal combustion engine according to another embodiment of the present invention comprises the above-mentioned fuel injection valve, the above-mentioned downstream air-fuel ratio sensor, a correction amount calculating section similar to the above-mentioned correction amount calculating section, a learning section similar to the above-mentioned learning section, and the above-mentioned fuel injection controlling section.

Note that the correction amount calculating section in the apparatus of this embodiment maintains the adjusting gain when the time integral value is calculated unchanged between the adjusting gain in the case in which the learning value is increasing and the adjusting gain in the case in which the learning value is decreasing.

Further, the learning section of this embodiment is configured so as to determine that the learning value has converged when the learning value is present between an upper limit value and a lower limit value over a predetermined time period, the upper maximum value being a value obtained by adding a positive first specific value to a “determination reference value which is calculated based on the past values of the learning value, and the lower limit value being a value obtained by subtracting a positive second specific value from the determination reference value.

In addition, the learning section sets the first specific value at a value larger than the second specific value, when the magnitude of the increasing speed of the learning value is larger than the magnitude of the decreasing speed of the learning value, and sets the second specific value at a value larger than the first specific value, when the magnitude of the decreasing speed of the learning value is larger than the magnitude of the increasing speed of the learning value.

According to this configuration, among the upper limit value and the lower limit value, a “threshold value on the side where the magnitude of the changing speed of the learning value is larger” greatly deviates from the determination reference value Vkijun as compared with a “threshold value on the side where the magnitude of the changing speed of the learning value is smaller.” Therefore, when the learning value has converged, the learning value is present “between the upper limit value and the lower limit value”, even if the magnitude of the increasing speed and the magnitude of the decreasing speed of the learning value are different from each other. As a result, it can be determined with high accuracy that the learning value has converged.

In addition, since the above-mentioned configuration determines whether or not the magnitude of the deviation of the learning value from the determination reference value in the predetermined time period exceeds “the first specific value or the second specific value”, the determination of whether or not the learning value has converged can be carried out in a shorter time period, as compared with the determination of whether or not the magnitude of the variation of the learning value in the predetermined time period exceeds the threshold value.

Further, it is unnecessary to set the first specific value and the second specific value at excessively large values, and thus, it can be avoided that the learning value is erroneously determined to have converged when the learning value has not converged. Furthermore, the adjusting gain is maintained at the same value as each other between when the learning value is increasing and when the learning value is decreasing. Therefore, it is possible to prevent the learning value from overshooting due to the excessive adjusting gain or to prevent the convergence of the learning value from being delayed due to the excessively small adjusting gain, or the like. As a result, the emissions can be maintained in a good condition.

In this case as well, the learning section is preferably configured to set the adjusting gain in the case in which it is not determined that the learning value has converged at a value larger than the adjusting gain in the case in which it is determined that the learning value has converged.

According to this configuration, since the adjusting gain is set at a large value when the learning value has not converged, it is possible to have the learning value rapidly come closer to the convergent value. Note that, in this aspect, the adjusting gain in the case in which the learning value is increasing and the adjusting gain in the case in which the learning value is decreasing are set to the same value as each other, when the learning value has not converged.

### BRIEF DESCRIPTION OF THE DRAWINGS

FIG. 1 is a schematic view of an internal combustion engine to which a fuel injection amount control apparatus (a first control unit) according to a first embodiment of the present invention is applied.

FIG. 2 is a graph showing a relationship between an output voltage of the upstream air-fuel ratio sensor shown in FIG. 1 and an air-fuel ratio.

FIG. 3 is a graph showing a relationship between an output voltage of the downstream oxygen concentration sensor shown in FIG. 1 and an air-fuel ratio.

FIG. 4 is a timing chart showing a changing state of the output value of the downstream air-fuel ratio sensor and a sub FB learning value.

FIGS. 5((A) and (B) of FIG. 5) is a timing chart showing a changing state of the sub FB learning value.

FIG. 6 is a functional block diagram illustrating functions when the electric control unit shown in FIG. 1 carries out a fuel injection amount control (air-fuel ratio control).

FIG. 7 is a functional block diagram of the base correction value calculating section shown in FIG. 6.

FIG. 8 is a flowchart illustrating a routine carried out by a CPU of the first control unit.

FIG. 9 is a flowchart illustrating a routine carried out by the CPU of the first control unit.

FIG. 10 is a flowchart illustrating a routine carried out by the CPU of the first control unit.

FIG. 11 is a flowchart illustrating a routine carried out by the CPU of the first control unit.

FIG. 12 is a flowchart illustrating a routine carried out by the CPU of the first control unit.

FIG. 13 is a flowchart illustrating a routine carried out by the CPU of the first control unit.

FIG. 14 is a flowchart illustrating a routine carried out by the CPU of the first control unit.

FIG. 15 is a flowchart illustrating a routine carried out by the CPU of the first control unit.

FIG. 16 is a flowchart illustrating a routine carried out by the CPU of the first control unit.

FIG. 17 is a timing chart for explaining an operation of a fuel injection amount control apparatus (a second control unit) according to a second embodiment of the present invention.

FIG. 18 is a flowchart illustrating a routine carried out by a CPU of the second control unit.

FIG. 19 is a flowchart illustrating a routine carried out by the CPU of the second control unit.

FIG. 20 is a flowchart illustrating a routine carried out by the CPU of the second control unit.

### DESCRIPTION OF EMBODIMENT

Hereinafter, a fuel injection amount control apparatus (hereinafter, simply referred to as a “control unit”) for an internal combustion engine according to each embodiment of the present invention will be described with reference to the drawings. This control unit is also an air-fuel ratio control apparatus for the internal combustion engine.

### First Embodiment

### (Constitution)

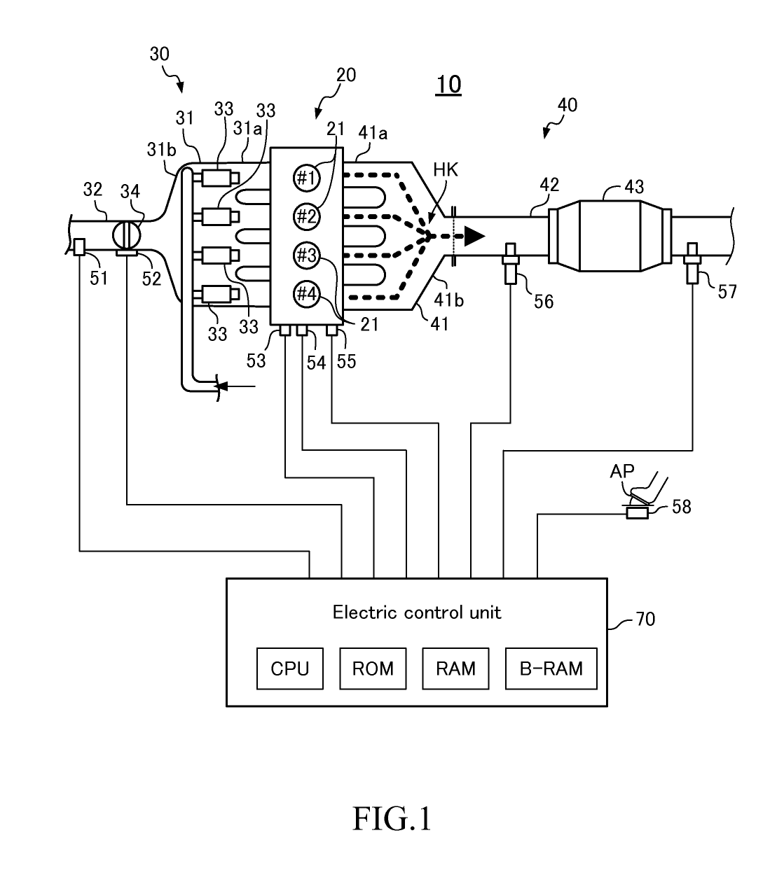

FIG. 1 illustrates a schematic configuration of a system where a control unit according to a first embodiment (hereinafter, referred to as a “first control unit”) is applied to a four-cycle/spark-ignition type/multi-cylinder (straight four-cylinder) internal combustion engine 10.

The internal combustion engine 10 includes an engine main body section 20, an intake system 30, and an exhaust system 40.

The engine main body section 20 includes a cylinder block section, and a cylinder head section. The main body section 20 has a plurality of cylinders (combustion chambers) 21. Each of the cylinders communicates with unillustrated “intake ports and exhaust ports.” The communicating portions between the intake ports and the combustion chambers are opened and closed by unillustrated intake valves. The communicating portions between the exhaust ports and the combustion chambers are opened and closed by unillustrated exhaust valves. Each of the combustion chambers 21 is provided with an unillustrated spark plug.

The intake system 30 comprises an intake manifold 31, an intake pipe 32, a plurality of fuel injection valves 33, and a throttle valve 34.

The intake manifold 31 includes a plurality of branch portions 31a and a surge tank 31b. An end of each of a plurality of the branch portions 31a is connected to each of a plurality of the intake ports. The other end of each of a plurality of the branch portions 31a is connected to the surge tank 31b.

An end of the intake pipe 32 is connected to the surge tank 31b. An unillustrated air filter is provided at the other end of the intake pipe 32.

Each of the fuel injection valves 33 is provided for each of the cylinders (combustion chambers) 21. The fuel injection valve 33 is disposed in the intake port. That is, each of a plurality of the cylinders comprises the fuel injection valve 33 for supplying the fuel independently from the other cylinders. The fuel injection valve 33 is configured so as to inject, in response to an injection instruction signal, a “fuel of an instructed injection amount included in the injection instruction signal” into a corresponding intake port (and thus, to a cylinder 21 corresponding to the fuel injection valve 33).

The throttle valve 34 is provided within the intake pipe 32 in such a manner that it is rotatable. The throttle valve 34 is adapted to change the opening cross sectional area of the intake passage. The throttle valve 34 is rotated within the intake pipe 32 by an unillustrated throttle valve actuator.

The exhaust system 40 includes an exhaust manifold 41, an exhaust pipe 42, an upstream-side catalytic converter (catalyst) 43 disposed in the exhaust pipe 42, and an “unillustrated downstream-side catalytic converter” disposed in the exhaust pipe 42 at a position downstream of the upstream-side catalyst 43.

The exhaust manifold 41 comprises a plurality of branch portions 41a and an aggregated (merging) portion 41b. An end of each of a plurality of branch portions 41a is connected to each of a plurality of the exhaust ports. The other end of each of a plurality of branch portions 41a is connected to the aggregated portion 41b. This aggregated portion 41b is a portion into which the exhaust gases discharged from a plurality of (two or more of, and in the present example, four of) the cylinders aggregate (merge), and therefore, is referred to as an exhaust gas aggregated portion HK.

The exhaust pipe 42 is connected to the aggregated portion 41b. The exhaust ports, the exhaust manifold 41, and the exhaust pipe 42 constitute an exhaust passage.

Each of the upstream catalyst 43 and the downstream catalyst is a so-called three-way catalyst unit (exhaust purifying catalyst) carrying an active component formed of a so-called noble metal (catalytic substance) such as platinum, rhodium, and palladium. Each of the catalysts has a function of oxidizing unburned combustibles (substances) such as HC, CO, and H₂ and reducing nitrogen oxides (NOx) when the air-fuel ratio of a gas flowing into each of the catalysts is an “air-fuel ratio within a window of the three-way catalyst (e.g., stoichiometric air-fuel ratio).” This function is also referred to as a catalytic function. Furthermore, each of the catalysts has an oxygen storage function for occluding (storing) oxygen. Each of the catalysts can purify the unburned combustibles and the nitrogen oxides even when the air-fuel ratio deviates from the stoichiometric air-fuel ratio, owing to the oxygen storage function. That is, the oxygen storage function expands the width of the window. The oxygen storage function is realized by an oxygen occluding (storing) substances such as ceria (CeO₂) carried by the catalyst.

This system includes a hot-wire air-flow meter 51, a throttle position sensor 52, a water temperature sensor 53, a crank position sensor 54, an intake-cam position sensor 55, an upstream air-fuel ratio sensor 56, a downstream air-fuel ratio sensor 57, and an accelerator opening sensor 58.

The air-flow meter 51 outputs a signal corresponding to a mass flow rate (intake air flow rate) Ga of an intake air flowing through the intake pipe 32. That is, the intake air flow rate Ga represents an intake air amount taken into the engine 10 per unit time.

The throttle position sensor 52 detects an opening of the throttle valve 34 (throttle valve opening), and outputs a signal representing the detected throttle valve opening TA.

The water temperature sensor 53 detects a temperature of a cooling water of the internal combustion engine 10, and outputs a signal representing the detected cooling water temperature THW. The cooling water temperature THW is a parameter representing a warming state of the engine 10 (temperature of the engine 10).

The crank position sensor 54 outputs a signal including a narrow pulse generated every time the crankshaft rotates 10° and a wide pulse generated every time the crankshaft rotates 360°. This signal is converted to an engine rotational speed NE by an electric control unit 70, which will be described later.

The intake-cam position sensor 55 outputs a single pulse when the intake camshaft rotates 90 degrees from a predetermined angle, when the intake camshaft rotates 90 degrees after that, and when the intake camshaft further rotates 180 degrees after that. Based on the signals from the crank position sensor 54 and the intake-cam position sensor 55, the electric control unit 70, which will be described later, obtains an absolute crank angle CA, while using, as a reference, a compression top dead center of a reference cylinder (e.g., the first cylinder). This absolute crank angle CA is set to “0° crank angle” at the compression top dead center of the reference cylinder, increases up to 720° crank angle in accordance with the rotational angle of the crank shaft, and is again set to 0° crank angle at that point in time.

The upstream air-fuel ratio sensor 56 is disposed in “either one of the exhaust manifold 41 and the exhaust pipe 42” and at a position between the aggregated portion 41b (exhaust gas merging/aggregated portion HK) of the exhaust manifold 41 and the upstream catalyst 43.

The air-fuel ratio sensor 56 is a “limiting-current-type wide range air-fuel ratio sensor including a diffusion resistance layer” disclosed in, for example, Japanese Patent Application Laid-Open (kokai) Nos. H11-72473, 2000-65782, and 2004-69547.

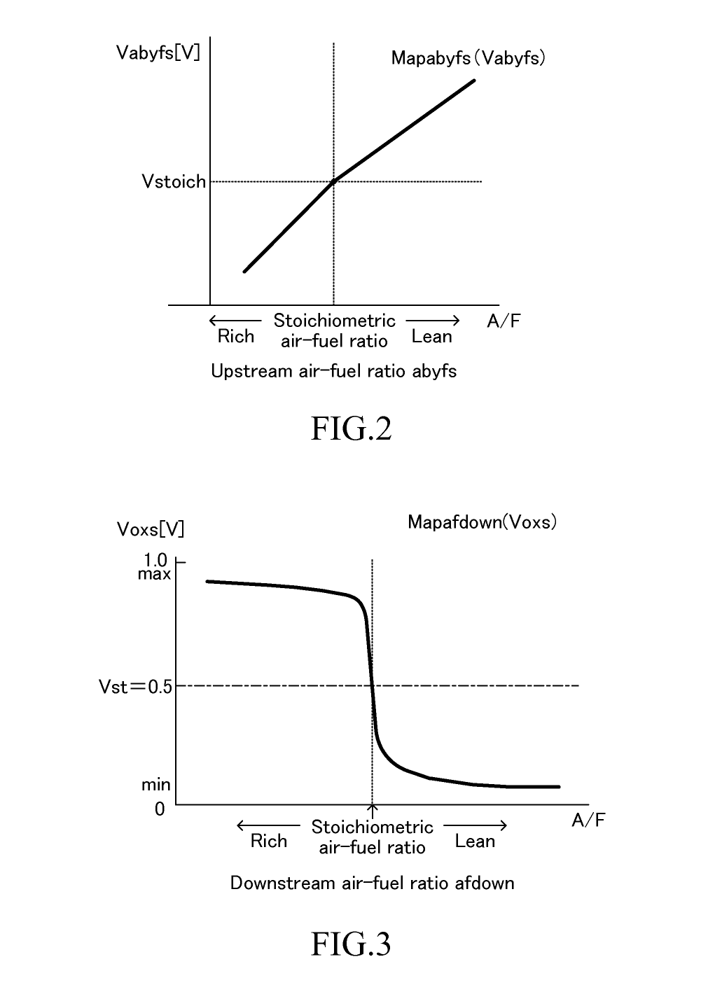

As shown in FIG. 2, the upstream air-fuel ratio sensor 56 outputs, as an “air-fuel ratio sensor output”, an output value Vabyfs which corresponds to the air-fuel ratio of the exhaust gas flowing at the position at which the upstream air-fuel ratio sensor 56 is disposed. This output value Vabyfs becomes larger as the air-fuel ratio of the gas reaching the upstream air-fuel ratio sensor 56 becomes larger (leaner). The output value Vabyfs becomes equal to a stoichiometric air-fuel ratio corresponding value Vstoich, when the air-fuel ratio of the gas reaching the air-fuel ratio sensor 56 is equal to the stoichiometric air-fuel ratio.

The electric control unit 70 described later stores a relationship as shown in FIG. 2 as an “air-fuel ratio conversion table Mapabyfs (Vabyfs)” in a ROM, and applies an actual output value Vabyfs to the air-fuel ratio conversion table Mapabyfs(Vabyfs) to obtain an upstream air-fuel ratio abyfs (detected air-fuel ratio abyfs).

Referring back to FIG. 1, the downstream air-fuel ratio sensor 57 is disposed in the exhaust pipe 42. A position at which the downstream air-fuel ratio sensor 57 is disposed is downstream of the upstream catalyst 43 and upstream of the downstream catalyst (i.e., in the exhaust passage between the upstream catalyst 43 and the downstream catalyst). The downstream air-fuel ratio sensor 57 is a well-known electro-motive-force-type oxygen concentration sensor (a well-known concentration-cell-type oxygen concentration sensor using stabilized zirconia). The downstream air-fuel ratio sensor 57 is designed to generate an output value Voxs corresponding to the air-fuel ratio of a gas to be detected, the gas flowing through a portion of the exhaust passage where the downstream air-fuel ratio sensor 57 is disposed. In other words, the output value Voxs is a value corresponding to the air-fuel ratio (downstream air-fuel ratio sensor afdown) of the gas which flows out of the upstream catalyst 43 and flows into the downstream catalyst.

As shown in FIG. 3, this output value Voxs becomes a maximum output value max (e.g., about 0.9 V-1.0 V) when the air-fuel ratio of the gas to be detected is richer than the stoichiometric air-fuel ratio. The output value Voxs becomes a minimum output value min (e.g., about 0.1 V-0 V) when the air-fuel ratio of the gas to be detected is leaner than the stoichiometric air-fuel ratio. Further, the output value Voxs becomes a voltage Vst (midpoint voltage Vst, e.g., about 0.5 V) which is approximately the midpoint value between the maximum output value max and the minimum output value min when the air-fuel ratio of the gas to be detected is equal to the stoichiometric air-fuel ratio. The output value Vox drastically changes from the maximum output value max to the minimum output value min when the air-fuel ratio of the gas to be detected changes from the air-fuel ratio richer than the stoichiometric air-fuel ratio to the air-fuel ratio leaner than the stoichiometric air-fuel ratio. Similarly, the output value Vox drastically changes from the minimum output value min to the maximum output value max when the air-fuel ratio of the gas to be detected changes from the air-fuel ratio leaner than the stoichiometric air-fuel ratio to the air-fuel ratio richer than the stoichiometric air-fuel ratio.

The accelerator opening sensor 58 shown in FIG. 1 is designed to output a signal which indicates the operation amount Accp of the accelerator pedal AP operated by the driver (accelerator pedal operation amount, opening degree of the accelerator pedal AP). The accelerator pedal operation amount Accp increases as the operation amount of the accelerator pedal AP becomes larger.

The electric control unit 70 is a well-known microcomputer which includes “a CPU; a ROM in which programs executed by the CPU, tables (maps and/or functions), constants, etc. are stored in advance; a RAM in which the CPU temporarily stores data as needed; a backup RAM; and an interface which includes an AD converter, etc.”

The backup RAM is supplied with an electric power from a battery mounted on a vehicle on which the engine 10 is mounted, regardless of a position (off-position, start position, on-position, and so on) of an unillustrated ignition key switch of the vehicle. While the electric power is supplied to the backup RAM, data is stored in (written into) the backup RAM according to an instruction of the CPU, and the backup RAM holds (retains, stores) the data in such a manner that the data can be read out. Accordingly, the backup RAM can keep the data while the engine 10 is stopped.

When the battery is taken out from the vehicle, for example, and thus, when the backup RAM is not supplied with the electric power, the backup RAM can not hold the data. Accordingly, the CPU initializes the data to be stored (sets the data to default values) in the backup RAM when the electric power starts to be supplied to the backup RAM again. The backup RAM may be replaced with a nonvolatile readable and writable memory such as an EEPROM.

The electric control unit 70 is connected to sensors described above so as to send signals from those sensors to the CPU. In addition, the electric control unit 70 is designed to send drive signals (instruction signals) to each of the spark plugs (in actuality, the igniters) provided for each of the cylinders, each of the fuel injection valves 33 provided for each of the cylinders, the throttle valve actuator, and the like, in response to instructions from the CPU.

The electric control unit 70 is designed to send the instruction signal to the throttle valve actuator so that the throttle valve opening TA increases as the obtained accelerator pedal operation amount Accp increases. That is, the electric control unit 70 has a throttle valve drive section for changing the opening of the “throttle valve 34 disposed in the intake passage of the engine 10” in accordance with the acceleration operation amount (accelerator pedal operation amount Accp) of the engine 10 which is changed by the driver.

### (Outline of Air-Fuel Ratio Control by First Control Unit)

The first control unit carries out a main feedback control in such a manner that the upstream air-fuel ratio abyfs represented by the output value Vabyfs of the upstream air-fuel ratio sensor 56 coincides with a predetermined target air-fuel ratio abyfr. Further, the first control unit carries out a sub feedback control in such a manner that the output value Voxs of the downstream air-fuel ratio sensor 57 coincides with a predetermined downstream target value Voxsref. The fuel injection amount is corrected by the feedback of the main feedback control and the sub feedback control.

In the sub feedback control, a sub feedback amount KSFB is calculated. This sub feedback amount KSFB operates so as to change the target air-fuel ratio abyfr. However, the sub feedback amount KSFB may operate so as to correct the output value Vabyfs of the upstream air-fuel ratio sensor 56.

The first control unit calculates the sub feedback amount KSFB according to a PID control based on a “difference (an output deviation amount DVoxs) between the output value Voxs and the downstream target value Voxsref.” That is, the sub feedback amount KSFB includes a proportional term, an integral term and a differential/derivative term.

In order to calculate the integral term of the sub feedback amount KSFB, the first control unit obtains a time integral value SDVoxslow by accumulating (integrating) a value obtained by multiplying the output deviation amount DVoxs (in actuality, a value DVoxslow obtained by low-pass-filtering the output deviation amount DVoxs) by a predetermined adjusting gain K. Note that the value DVoxslow can be substantially called a deviation (an output deviation amount) between the output value Voxs and the downstream target value Voxsref. Further, the first control unit obtains the integral term of the sub feedback amount KSFB by multiplying the time integral value SDVoxslow by an integral constant.

The first control unit obtains, as a learning value (a sub FB learning value KSFBg) of the sub feedback amount, a value corresponding to the integral term of the sub feedback amount KSFB. The sub FB learning value KSFBg is stored in the backup RAM, and is used to correct the fuel injection amount at least when a “sub feedback control condition for updating the sub feedback amount is not satisfied.”

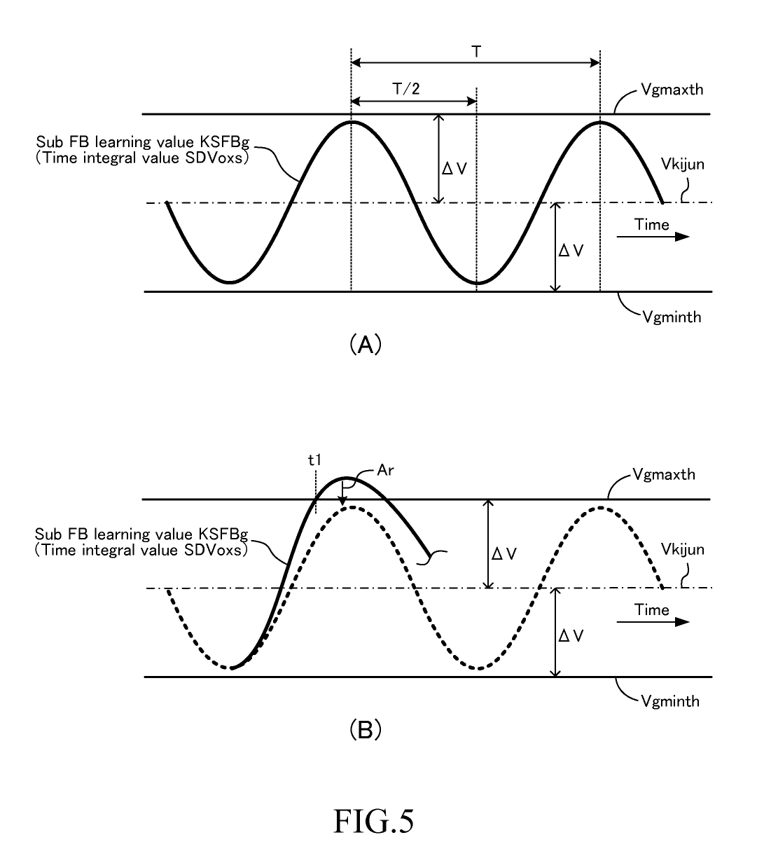

On the one hand, as shown in FIG. 5, the first control unit obtains a determination reference value Vkijun which represents a variation/fluctuation center of the sub FB learning value KSFBg (a weighted average value of the sub FB learning value KSFBg) until a certain point in time. Thereafter, the first control unit obtains an upper limit value Vgmaxth by adding a positive specific value ΔV to the determination reference value Vkijun, and obtains a lower limit value Vgminth by subtracting the specific value ΔV from the determination reference value Vkijun. The specific value ΔV is set to a value which becomes smaller, as a probability that the sub FB learning value KSFBg (convergence degree of the sub FB learning value KSFBg) is determined to be higher (that is, as a value of a status which will be described later is larger).

The first control unit determines that the convergence degree of the sub FB learning value KSFBg has risen (the learning value is approaching a convergent value), when “the sub FB learning value KSFBg is present between the upper limit value Vgmaxth and the lower limit value Vgminth” over a predetermined time period. On the contrary, the first control unit determines that the convergence degree of the sub FB learning value KSFBg has lowered (the learning value has deviated more greatly from the convergent value), when “the sub FB learning value KSFBg is not present (becomes absent) between the upper limit value Vgmaxth and the lower limit value Vgminth” in the predetermined time period. The convergence degree of the sub FB learning value KSFBg is represented by a value of the status which is described below.

status 0 (where the status is “0”): The convergence state of the sub FB learning value KSFBg is not good. That is, the state of the status 0 indicates/means an “unstable state” in which “the sub FB learning value KSFBg deviates from its convergent value SDVoxsfinal”, and “the changing speed of the sub FB learning value KSFBg is large.”

status 2 (where the status is “2”): The convergence state of the sub FB learning value KSFBg is good. That is, the state of the status 2 indicates/means a “stable state” in which the sub FB learning value KSFBg is stable in the vicinity of its convergent value SDVoxsfinal.” It can be said that the stable state means a state in which the learning of the sub FB learning value KSFBg has completed.

status 1 (where the status is “1”): The convergence state of the sub FB learning value KSFBg is a state (i.e., a quasi-state) between the above-mentioned stable state and the above-mentioned unstable state.

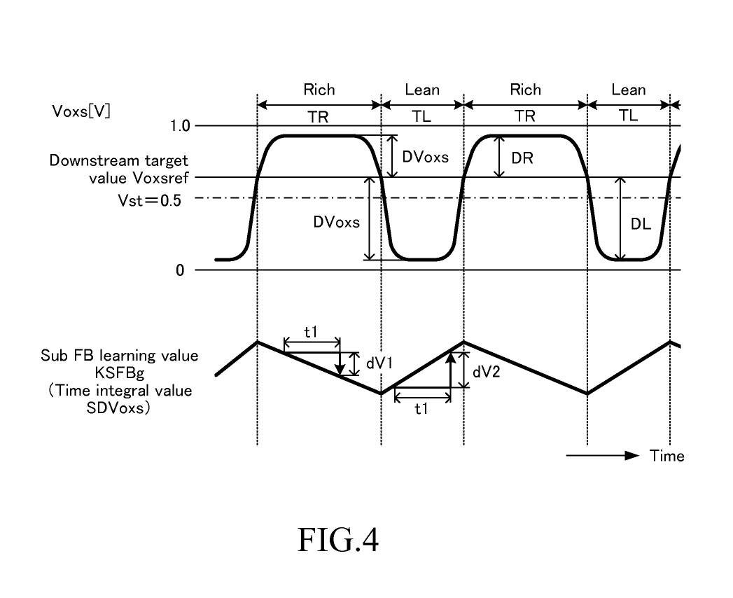

Meanwhile, in the first control unit, the downstream target value Voxsref is set at a value (such as 0.7 V) larger than the value Vst (such as 0.5 V) corresponding to the stoichiometric air-fuel ratio. As a result, as shown in FIG. 4, a magnitude DR of the output deviation amount DVoxs in a rich determination period is smaller than a magnitude DL of the output deviation amount DVoxs in a lean determination period. Therefore, if the adjusting gain K in the rich determination period is kept at the same value as one in the lean determination period, a single-time update amount (a low-pass-filtered value of K·DL) for the time integral value SDVoxslow in the lean determination period is larger than a single-time update amount (a high-pass-filtered value of K·DR) of the time integral value SDVoxs in the rich determination period. As a result, the updating speed of the sub FB learning value KSFBg is larger in the lean determination period than one in the rich determination period.

Therefore, even when the sub FB learning value KSFBg is substantially has converged into the convergent value SDVoxsfinal, there may be a case in which the sub FB learning value KSFBg goes beyond the upper limit value Vgmaxth due to an external disturbance, as shown at time point t1 of (B) of FIG. 5.

In view of the above, the first control unit sets the adjusting gain K when increasing the time integral value SDVoxslow to (at) a value smaller than the adjusting gain K when decreasing the time integral value SDVoxslow, so that a difference between the magnitude of the increasing speed of the sub FB learning value KSFBg and the magnitude of the decreasing speed of the sub FB learning value KSFBg becomes smaller (in other words, in such a manner that a difference between the magnitude of the increasing speed of the time integral value SDVoxslow and the magnitude of the decreasing speed of the time integral value SDVoxslow becomes smaller). As a result, the convergence state of the sub FB learning value KSFBg can be determined with high accuracy.

### (Detail of Air-Fuel Ratio Control)

The air-fuel ratio control of the engine carried out by the first control unit will next be described. As described above, the first control unit carries out a sub feedback control so as to have the output value Voxs of the downstream air-fuel ratio sensor 57 coincide with the downstream target value Voxsref.

In the mean time, since the upstream catalyst 43 has the oxygen storage function, a change in the air-fuel ratio at the upstream side of the upstream catalyst 43 appears as a change in the air-fuel ratio at the downstream side of the upstream catalyst 43 after a predetermined delay time period has passed. Therefore, it is difficult to sufficiently suppress a transient fluctuation of the air-fuel ratio only by the sub feedback control. In view of the above, as described above, the first control unit carries out the air-fuel ratio feedback control (main feedback control) based on the output value Vabyfs of the upstream air-fuel ratio sensor 56.

The first control unit carries out the air-fuel ratio control by a plurality of sections which will be described below, in order to avoid a state where the air-fuel ratio of the engine is decreased by the sub feedback control while the air-fuel ratio of the engine is increased by the main feedback control, and to avoid a state where the air-fuel ratio of the engine is increased by the sub feedback control while the air-fuel ratio of the engine is decreased by the main feedback control. This can avoid an interference of a control between the main feedback control and the sub feedback control.

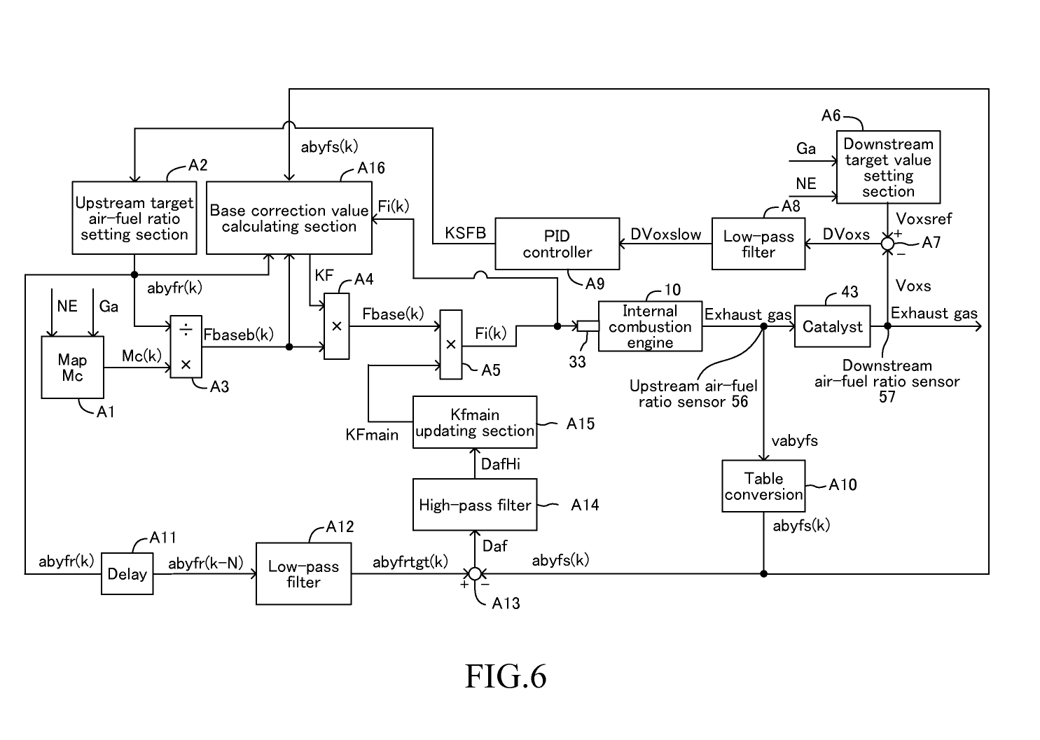

The first control unit is constructed by including a plurality of sections, and the like, as illustrated in FIG. 6 which is a functional block diagram.

### <Calculation of Post-Correction Base Fuel Injection Amount>

An in-cylinder intake air amount calculating section A1 obtains an in-cylinder intake air amount Mc(k) which is an intake air amount of a cylinder which is about to perform a current intake stroke, based on an actual intake air amount Ga, an actual engine rotational speed NE, and a look-up table MapMc stored in the ROM. Note that a subscript/suffix (k−N) indicates a value for an intake stroke N-strokes (in a four-cylinder engine, N·180° CA where CA is a crank angle) before the current intake stroke. Therefore, a variable having a subscript (k) indicates a value corresponding to the current intake stroke (or at a present point in time). This expression way is similarly used for the other parameters, hereinafter. The in-cylinder intake air amount Mc is stored in the RAM while being related to the intake stroke of each cylinder.

An upstream target air-fuel ratio setting (determining) section A2 determines the upstream target air-fuel ratio (target air-fuel ratio) abyfr(k) based on the engine rotational speed NE, the engine load (such as a throttle value opening TA), and the like, which are driving states of the internal combustion engine 10. As will be described later, the target air-fuel ratio abyfr is corrected by the “sub feedback amount KSFB which realize the sub feedback control.” The upstream target air-fuel ratio abyfr(k) is a base value of a target value for the detected air-fuel ratio abyfs obtained based on the output value of the upstream air-fuel ratio sensor 56. The target air-fuel ratio abyfr(k) is stored in the RAM while being related to the intake stroke of each cylinder.

A pre-correction base fuel injection amount calculating section A3 obtains a base fuel injection amount Fbaseb(k) by dividing the in-cylinder intake air amount Mc(k) obtained by the section A1 by the upstream target air-fuel ratio abyfr(k) obtained by the section A2, as shown in a formula (1) below. The base fuel injection amount Fbaseb(k) is a base fuel injection amount before it is corrected by a base correction valued KF, and the like, which will be described later, and therefore, the base fuel injection amount Fbaseb(k) is also referred to as a pre-correction base fuel injection amount Fbaseb(k). The pre-correction base fuel injection amount Fbaseb(k) is stored in the RAM while being related to the intake stroke of each cylinder.

Fbaseb(k)=Mc(k)/abyfr(k) (1)

A post-correction base fuel injection calculating section A4 obtains a post-correction base fuel injection amount Fbase(k) (=KF·Fbaseb(k)) by multiplying the pre-correction base fuel injection amount Fbaseb(k) currently-obtained by the section A3 by a base correction value KF. The base correction value KF is obtained by a base correction value calculating section A16 which will be described later, and is stored in the backup RAM.

### <Calculation of Final Fuel Injection Amount>

A final fuel injection amount calculating section A5 obtains a current final fuel injection amount Fi(k) by multiplying the post-correction base fuel injection amount Fbase(k) (=KF·Fbaseb(k)) by a main feedback correction value KFmain, as shown by a formula (2) below. The final base fuel injection amount Fi(k) is stored in the RAM while being related to the intake stroke of each cylinder. The main feedback correction value KFmain is obtained by a main feedback correction value updating section A15 which will be described later.

Fi(k)=(KF·Fbaseb(k))·KFmain=Fbase(k)·KFmain (2)

The first control unit transmits/sends the injection instruction signal to the fuel injection value 33 corresponding the cylinder which is about to perform the current intake stroke so that the fuel of that final fuel injection amount Fi(k) is injected from that fuel injection valve 33. In other words, the injection instruction signal includes information regarding the final fuel injection amount Fi(k) as the instructed fuel injection amount.

### <Calculation of Sub Feedback Amount>

A downstream target value setting section A6 determines the downstream target value Voxsref corresponding to a downstream target air-fuel ratio based on “the engine rotational speed NE, the intake air amount Ga, the throttle value opening TA, the deterioration degree of the upstream catalyst 43 (the maximum oxygen storage amount Cmax), and the like.”

An output deviation amount calculating section A7 obtains the output deviation amount DVoxs by subtracting the output value Voxs of the downstream air-fuel ratio sensor 57 at the present point in time from the downstream target value Voxsref at the present point in time which is set by the section A6 according to a formula (3) below. Note that the “present point in time” is a point in time of a start of the fuel injection instruction for the current Fi(k). The output deviation amount calculating section A7 outputs the obtained output deviation amount DVoxs to a low-pass filter A8.

DVoxs=Voxsref−Voxs (3)

The low-pass filter A8 is a first-order digital filter. A transfer function A8(s) representing the characteristics of the low-pass filter A8 is shown by a formula (4) below. In the formula (4), s is a Laplace operator, and τ1 is a time constant. The low-pass filter A8 substantially prohibits a transmission of a high frequency component which is equal to or larger than a frequency (1/τ1). The low-pass filter A8 inputs a value of the output deviation amount DVoxs to perform a low-pass filtering process on the value of the output deviation amount DVoxs, and outputs a post-low-pass filtered output deviation amount DVoxslow which is the low-pass filtered value of the output deviation amount DVoxs to a PID controller A9.

A8(s)=1/(1+τ1·s) (4)

The PID controller A9 calculates the time integral value (integral processed value) SDVoxslow by performing an integral process on the post-low-pass filtered output deviation amount DVoxslow, according to a formula (5) below. SDVoxslow(n) in the left side is a post-updated time integral value, and SDVoxslow(n−1) in the right side is a pre-updated time integral value. K is an adjusting gain (an adjusting value), and is set and changed as will be described later. That is, a single-time update amount of the time integral value SDVoxslow is a value K·DVoxslow obtained by multiplying the output deviation amount DVoxslow by the adjusting gain K. The adjusting gain K is varied to change the updating speed (the changing speed) of the time integral value SDVoxslow. In the first control unit, the adjusting gain K is set to (at) a value when the output value Voxs is larger than the downstream target value Voxsref, which is different from a value when the output value Voxs is smaller than the downstream target value Voxsref, or vice versa.

SDVoxslow(n)=SDVoxslow(n−1)+K·DVoxslow (5)

Subsequently, the PID controller A9 carries out a proportional-integral-derivative process (PID process) according to a formula (6) below to obtain the sub feedback amount KSFB. In the formula (6), Kp is a preset proportional gain (a proportional constant), Ki is a preset integral gain (an integral constant), and Kd is a preset derivative gain (a derivative constant). DDVoxslow is a time derivative/differential value of the post-low-pass filtered output deviation amount DVoxslow. In this manner, the sub feedback amount KSFB is obtained.

KSFB=Kp·DVoxslow+Ki·SDVoxslow+Kd·DDVoxslow (6)

Since the above-mentioned formula (6) includes the integral term Ki SDVoxslow, it is ensured that the output deviation amount DVoxs becomes zero in a steady state. In other words, a steady deviation between the downstream Voxsref and the output value Voxs of the downstream air-fuel ratio sensor 57 becomes zero. Further, in the steady state, since the output deviation amount DVoxs becomes zero, both the proportional term Kp·DVoxslow and the deviation term Kd·DDVoxslow become zero. Therefore, the convergence value of the sub feedback amount KSFB in the steady state becomes equal to the value of the integral term Ki·SDVoxslow.

As is apparent from the description above, the downstream target value setting section A6, the output deviation calculating section A7, the low-pass filter A8, and the PID controller A9 constitute a sub feedback amount calculating section.

### <Main Feedback Control>

As described above, the upstream catalyst 43 has the oxygen storage function. Therefore, a “high frequency component having a relatively high frequency (high frequency component equal to or higher than the above-mentioned frequency 1/τ1)” in the fluctuation of the air-fuel ratio of the exhaust gas upstream of the upstream catalyst 43, and a “low frequency component having a relatively low frequency and a relatively small amplitude (low frequency component, which fluctuates at a frequency equal to or lower than the above-mentioned frequency 1/τ1, and which has a relatively small deviation amount from the stoichiometric air-fuel ratio” in the fluctuation of the air-fuel ratio of the exhaust gas upstream of the upstream catalyst 43 are absorbed by the oxygen storage function of the upstream catalyst 43. Accordingly, it is unlikely that they appears as a fluctuation of the air-fuel ratio of the exhaust gas downstream of the upstream catalyst 43.

Therefore, the sub feedback control can not compensate for a “rapid change in the air-fuel ratio in a transient driving state” such as a large fluctuation of the air-fuel ratio of the exhaust gas at a high frequency equal to or higher than the frequency (1/τ1), for example. Therefore, in order to certainly compensate for the “rapid change of the air-fuel ratio in the transient driving state”, a main feedback control based on the output value Vabyfs of the upstream air-fuel ratio sensor 56 needs to be carried out.

Meanwhile, a “low frequency component whose frequency is relatively low and whose amplitude is relatively large (e.g., a low frequency component fluctuating at a frequency equal to or lower than the frequency (1/τ1) and having a relatively large deviation amount from the stoichiometric air-fuel ratio)” in the fluctuation of the air-fuel ratio of the exhaust gas upstream of the upstream catalyst 43 can not completely be absorbed by the oxygen storage function of the upstream catalyst 43. Therefore, such a fluctuation of the air-fuel ratio upstream of the upstream catalyst 43 appears as a fluctuation of the air-fuel ratio downstream of the upstream catalyst 43 with a predetermined delay time period. As a result, the above mentioned control interference may occur between the main feedback control and the sub feedback control, since a case may occur in which the output value Vabyfs of the upstream air-fuel ratio sensor 56 is on the rich side with respect to the target air-fuel ratio abyfr, while the output value Voxs of the downstream air-fuel ratio sensor 57 is on the lean side with respect to the downstream target value Voxsref, and the like.

In view of the above, the first control unit cuts out (eliminate) a “low frequency component equal to or lower than a predetermined frequency (in the present example, a frequency (1/τ1)) corresponding to a frequency component which appears as a fluctuation of the air-fuel ratio downstream of the upstream catalyst 43” from the fluctuation of the output value Vabyfs of the upstream air-fuel ratio sensor 56, and uses a value corresponding to the post-eliminated value Vabyfs of the upstream air-fuel ratio sensor 56 in the main feedback control. The “value corresponding to the output value Vabyfs of the upstream air-fuel ratio sensor 56” used in the main feedback control is a value obtained by performing a high-pass-filtering process on a difference Daf between the target air-fuel ratio abyfrtgt(k) and the output value Vabyfs(k).” As a result, the above-mentioned interference in the air-fuel ratio control can be avoided, and the rapid change of the air-fuel ratio in the transient driving state can be certainly compensated by the main feedback control. More specifically, the main feedback correction value is obtained as follows.

### <Calculation of Main Feedback Correction Value>

A table conversion section A10 obtains a current detected air-fuel ratio abyfs(k) based on the output value Vabyfs of the upstream air-fuel ratio sensor 56 and the table Mapabyfs as shown in FIG. 2.

A target air-fuel ratio delaying section A11 reads out an upstream target air-fuel ratio abyfr N-strokes (N-times intake strokes) before the present point in time from the RAM, and sets it as an upstream target air-fuel ratio abyfr(k−N). The upstream target air-fuel ratio abyfr(k−N) is an upstream target air-fuel ratio which was used for calculating a pre-correction base fuel amount Fbaseb(k−N) of a cylinder performing an intake stroke N-strokes before the present point in time.

The above-mentioned value N varies depending on a displacement of the internal combustion engine 10, a distance from the combustion chamber 21 to the upstream air-fuel ratio sensor 56, and the like. The reason why the actual upstream target air-fuel ratio abyfr(k−N) N-strokes before the present point in time is used for calculating the main feedback correction value is that it takes an idle time period L1 corresponding to the N-strokes for a mixture including fuel injected from the fuel injection value 33 and burned within the combustion chamber 21 to reach the upstream air-fuel ratio sensor 56. Note that it is preferable that the value N be changed to a value which becomes smaller, as the engine rotational speed NE becomes higher, and as the load of the engine (e.g., the in-cylinder intake air amount Mc) becomes larger.

A low-pass filter A12 performs a low-pass filtering process on the upstream target air-fuel ratio abyfr(k−N) outputted from the section A11, to calculate a target air-fuel ratio for the main feedback control (a target air-fuel ratio for the upstream feedback control) abyfrtgt(k). The target air-fuel ratio for the main feedback control abyfrtgt(k) is a value corresponding to the upstream target air-fuel ratio abyfr(k−N) determined by the upstream target air-fuel ratio setting section A2.

The low-pass filter A12 is a first-order digital filter. A transfer function A12(s) of the low-pass filter A12 is shown by a formula (7) below. In the formula (7), s is a Laplace operator, and τ is a time constant (a parameter relating to responsivity). The characteristics substantially prohibit a transmission of a high frequency component equal to or higher than the frequency (1/τ).

A12(s)=1/(1+τ·s) (7)

If an input signal is a value of the air-fuel ratio of exhaust gas reaching the upstream air-fuel ratio sensor 56, and an output signal is a value of the air-fuel ratio obtained based on the output value Vabyfs of the upstream air-fuel ratio sensor 56, the output signal is very similar to a signal obtained by performing a low-pass filtering process (for example, a first-order lag process, a second-order lag process, and the like, including a so-called “blurred (weighted) process”) on the input signal. As a result, the target air-fuel ratio abyfrtgt(k) for the main feedback control generated by the low-pass filter A12 becomes a value which the upstream air-fuel ratio sensor 56 would actually output when the exhaust gas having a preferable/appropriate air-fuel ratio in accordance with the target air-fuel ratio abyfr(k−N) reaches the upstream air-fuel ratio sensor 56.

An upstream air-fuel ratio deviation calculating section A13 obtains the air-fuel ratio deviation Daf by subtracting the currently-detected air-fuel ratio abyfr(k−N) from the target air-fuel ratio abyfrtgt(k) for the main feedback control, according to a formula (8) below. The air-fuel ratio deviation Daf is an amount representing a deviation (error) between the actual air-fuel ratio of the air-fuel mixture supplied to the cylinder the N-strokes before the present point in time and the target air-fuel ratio.

Daf=abyfrtgt(k)−abyfs(k) (8)

A high-pass filter A14 is a first-order digital filter. A transfer function A14(s) representing the characteristics of the high-pass filter A14 is shown by a formula (9). In the formula (9), s is a Laplace operator, and τ1 is a time constant. The time constant τ1 is the same as the time constant τ1 of the low-pass filter A8. The high-pass filter A14 substantially prohibits a transmission of a low frequency component having a frequency equal to or lower than the frequency (1/τ1).

A14(s)={1−1/(1+τ1·s)} (9)

The high-pass filter A14 inputs the air-fuel ratio deviation Daf, and performs the high-pass filtering process on the air-fuel ratio deviation Daf in accordance with the above-mentioned formula (9) to output a deviation DafHi for the main feedback control which is the post-high-pass-filtered value of the air-fuel ratio deviation Daf.

A main feedback correction value updating section A15 performs a proportional process on the deviation DafHi for the main feedback control which is the output value of the high-pass filter A14. That is, the main feedback correction value updating section A15 obtains a main feedback correction value KFmain by adding “1” to a value obtained by multiplying the deviation DafHi for the main feedback control by a proportional gain GpHi. The main feedback correction value KFmain is used when the final fuel injection amount calculating section A5 obtains a current final fuel injection amount Fi(k).

Note that the main feedback correction value updating section A15 may obtain the main feedback correction value KFmain by performing a proportional and integral process (PI process) on the deviation DafHi for the main feedback control according to a formula (10) below. In the formula (10), Gphi is a preset proportional gain (a proportional constant), and Gihi is a preset integral gain (an integral constant). SDafHi is a time integral value of the deviation DafHi for the main feedback control. A coefficient KFB is “1” in the present example. It is preferable that the coefficient KFB be varied in accordance with the engine rotational speed NE, the in-cylinder intake air amount Mc, and the like.

KFmain=1+(Gphi·DafHi+Gihi·SDafHi)·KFB (10)

As is clear from the description above, the upstream target air-fuel ratio setting section A2, the table conversion section A10, the target air-fuel ratio delaying section A11, the low-pass filter A12, the upstream air-fuel ratio deviation calculating section A13, the high-pass filter A11, and the main feedback correction value updating section A15 constitute a main feedback correction value calculating section (an main feedback control section).

### <Calculation of Base Correction Value>

The sub feedback amount KSFB is calculated by performing a proportional, integral and derivative process on the post-low-pass filtered output deviation amount DVoxslow by the PID controller A9. However, the change in the air-fuel ratio of the engine appears as the change in the air-fuel ratio of the exhaust gas downstream of the upstream catalyst 43 due to the an effect of the oxygen storage function of the upstream catalyst 43. Therefore, when a magnitude of the steady error due to a detection accuracy of the airflow meter 51 and an estimated accuracy of an air amount estimating model relatively rapidly has increased by a rapid change of a driving region or the like, it is impossible to immediately compensate for an excess and deficiency in the fuel injection amount caused by that error only by the sub feedback control.

Meanwhile, in the main feedback control with no effect by the oxygen storage function of the upstream catalyst 43, the high-pass filtering process by the high-pass filter A14 is a process exhibiting the same function as that of a derivative process (D process). Therefore, in the above-mentioned main feedback control where the post-high-pass-filtered value by the high pass filter A14 is the input value of the main feedback correction value updating section A15, it is not possible to calculate a main feedback correction value KFmain which includes a substantial integral term, even if the main feedback correction value updating section A15 is configured so as to carry out an integral process to obtain the main feedback correction value KFmain. Accordingly, the above-mentioned main feedback control can not compensate for the steady error of the fuel injection amount due to the detection accuracy of the airflow meter and the estimated accuracy of the air amount estimating model. As a result, when the driving region is changed or the like, there may be a possibility that the amount of generated exhaust gas with harmful components is temporarily increased.

In view of the above, in order to compensate for the above-mentioned steady error, the first control unit obtains a base correction amount KF to correct the pre-correction base fuel injection amount Fbaseb. Further, as illustrated in the formula (11) below again, the first control unit obtains the post-correction base fuel injection amount Fbase(k) by the base correction value KF, and thereafter, corrects the post-correction base fuel injection amount Fbase(k) with the main feedback value KFmain.

Fi(k)={KF·Fbaseb(k)}·KFmain (11)

The base correction value KF is defined by a formula (12) below.

Fbaset(k−N)=KF·Fbaseb(k−N) (12)

In formula (12), Fbaset is a true instruction injection amount in order to obtain/realize the target air-fuel ratio, and may be said to be a base fuel injection amount with no error. Hereinafter, Fbaset is referred to as a “true base fuel amount.” The true base fuel injection amount Fbaset(k−N) in the formula (12) is calculated by a formula (13) below.

Fbaset(k−N)=(abyfs(k)·Fi(k−N))/abyfr(k−N) (13)

The following description is added regarding the above-mentioned formula (13). The above-mentioned N-strokes is set to the number of the strokes corresponding to the above-mentioned “idle time period.” That is, the currently-detected air-fuel ratio abyfs(k) is an air-fuel ratio caused by the fuel injected based on the final fuel injection amount Fi(k−N). Therefore, the numerator abyfs(k)·Fi(k−N) in the right side of formula (13) represents an in-cylinder air amount when the final fuel injection amount Fi(k−N) was determined. Accordingly, as shown in the formula (13), the true base fuel injection amount Fbaset(k−N) is calculated by dividing the in-cylinder air amount (abyfs(k)·Fi(k−N)) at the point in time when the final fuel injection amount Fi(k−N) was determined by the target air-fuel ratio abyfr(k−N) at the point in time when the final fuel injection amount Fi(k−N) was determined.

On the one side, the pre-correction base fuel injection amount Fbaseb(k) used in the above-mentioned formula (12) is obtained according to a formula (14) below.

Fbaseb(k)=Mc(k)/abyfr(k) (14)

Accordingly, the first control unit obtains the base correction amount KF according to a formula (15) below, which is obtained from the above-mentioned formulas (12)-(14), and stores the obtained base correction amount KF in the memory while being related to (in correspondence with) a driving region when this base correction value KF was calculated.

$$\begin{matrix}KF = Fbaset ( k \text{-} N ) / Fbaseb ( k \text{-} N ) \\ = \{ abyfs ( k ) \cdot Fi ( k \text{-} N ) / abyfr ( k \text{-} N ) \} / \{ Mc ( k \text{-} N ) / abyfr ( k \text{-} N ) \}\end{matrix} \qquad ( 15 )$$

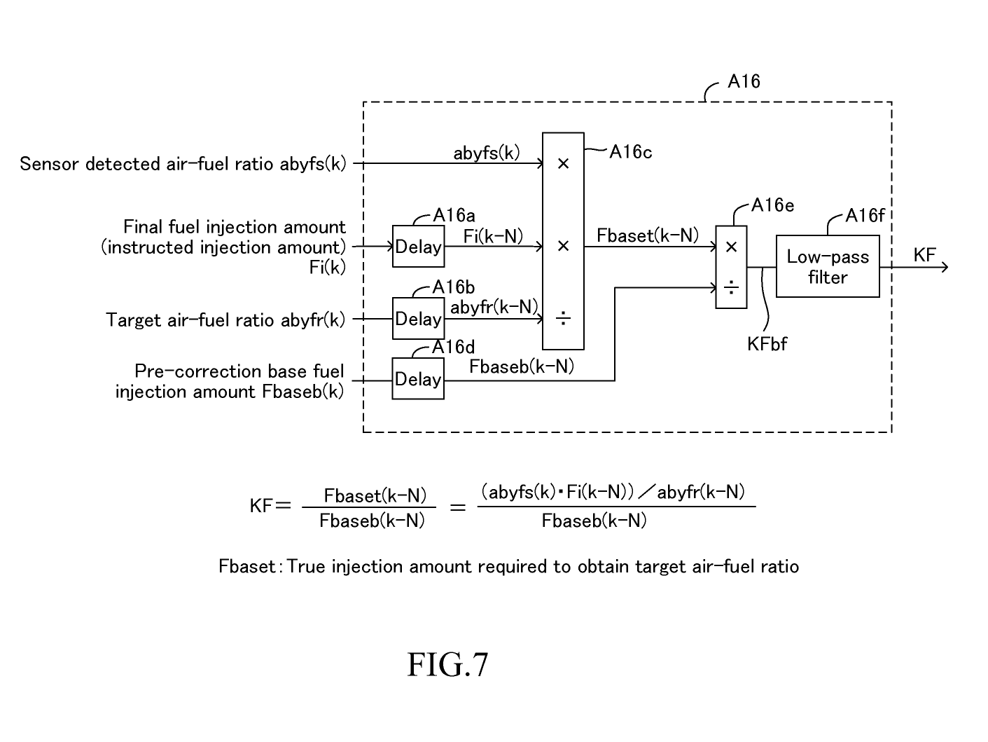

The base correction value KF is calculated by a base correction value calculating section A16 which is constructed in accordance with a principle represented by the above-mentioned formula (15). Hereinafter, an actual method for calculating the base correction value KF is described with reference to FIG. 7 which shows a functional block diagram of the base correction value calculating section A16. The base correction value calculating section A16 is constructed by including section A16a to A16f, and the like.

A final fuel injection amount delaying section A16a delays the current final fuel injection amount Fi(k) to obtain a final fuel injection amount Fi(k−N) N-strokes before the present point in time. In actuality, the final fuel injection amount delaying section A16a reads out the final fuel injection amount Fi(k−N) from the RAM.

A target air-fuel ratio delaying section A16b delays the current target air-fuel ratio abyfr(k) to obtain a target air-fuel ratio abyfr(k−N) N-strokes before the present point in time. In actuality, the target air-fuel ratio delaying section A16b reads out the target air-fuel ratio abyfr(k−N) from the RAM.

A true base fuel injection amount calculating section A16c obtains the true base fuel injection Fbaset(k−N) N-strokes before the present point in time in accordance with the above-mentioned formula (13) (Fbaset(k−N)=abyfs(k)·Fi(k−N))/abyfr(k−N)).

A pre-correction fuel injection amount delaying section A16d delays the current pre-correction fuel injection amount Fbaseb(k) to obtain a pre-correction fuel injection amount Fbaseb(k−N) N-strokes before the present point in time. In actuality, the pre-correction fuel injection amount delaying section A16d reads out the pre-correction fuel injection amount Fbaseb(k−N) from the RAM.

A pre-filtering base correction value calculating section A16e calculates a pre-filtering base correction value KFbf by dividing the true base fuel injection amount Fbaset(k−N) by the pre-correction base fuel injection amount Fbaseb(k−N) in accordance with the formula (KFbf=Fbaset(k−N)/Fbaseb(k−N)) according to the above-mentioned formula (15).

A low-pass filter A16f calculates a base correction value KF by performing a low-pass filtering process on the pre-filtering base correction value KFbf. This low-pass filtering process is carried out in order to stabilize the base correction value KF (in order to eliminate a noise component superposed onto the pre-filtering base correction value KFbf). The thus obtained base correction value KF is memorized and stored in the RAM and the backup RAM while being related to (in correspondence with) a driving region to which the driving state N-strokes before the present point in time belongs.

In this manner, the base correction value calculating section A16 updates the base correction value KF using each of the sections A16a to A16f when every calculating point in time for the final fuel injection amount Fi(k) comes. Further, the base correction value calculating section A16 reads out the base correction value KF stored in the driving region of the backup RAM to which the driving state of the engine 10 belongs at the calculating point in time of the final fuel injection amount Fi(k), and provides the read base correction value KF to the post-correction base fuel injection calculating section A4. As a result, the steady error of the fuel injection amount (the pre-correction base fuel injection amount) is rapidly compensated. Those descriptions summarize the main feedback control and the sub feedback control of the first control unit.

### (Actual Operation)

An actual operation of the first control unit will next be described. Hereinafter, for the sake of convenience of the description, “MapX(a1, a2, . . . )” represents a look-up table for obtaining a value X where a1, a2, . . . are arguments. When the argument is a value detected by a sensor, the current detected value by the sensor is used as the argument.

### <Calculation of Final Fuel Injection Amount Fi(k)>

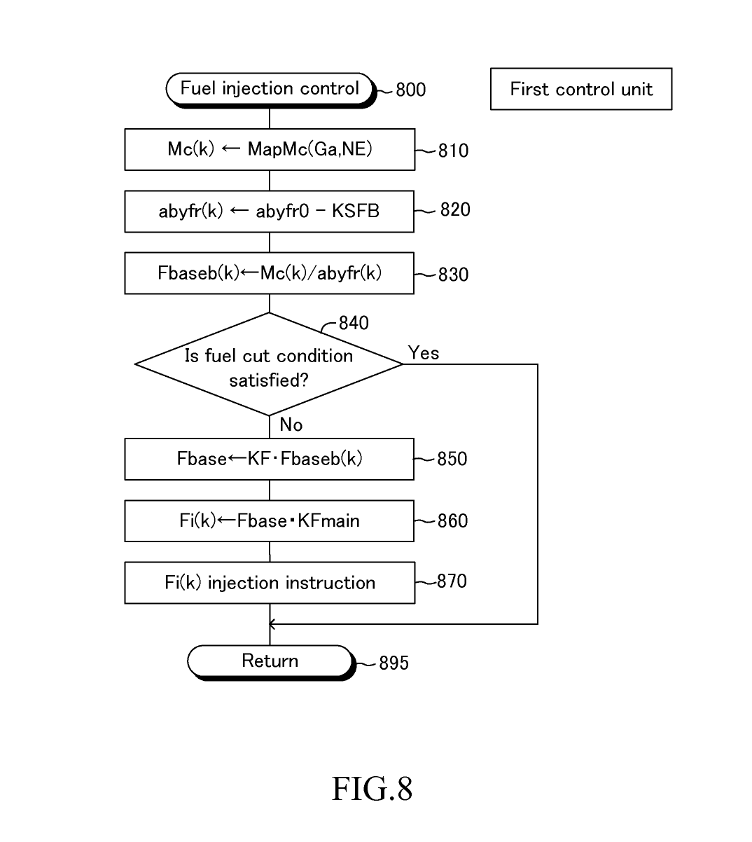

A CPU is designed to repeatedly execute a routine shown by a flowchart in FIG. 8 for calculating the final fuel injection amount Fi and giving the injection instruction each time the crank angle of each cylinder reaches a predetermined crank angle (e.g., BTDC 90° CA) before the intake top dead center of the cylinder. Therefore, when the crank angle of an arbitrary cylinder reaches the above-mentioned predetermined crank angle, the CPU starts a process from step 800, and sequentially carries out processes from step 810 to step 830 one after another, to proceed to step 840.

Step 810: The CPU estimates/determines a current in-cylinder intake air amount Mc(k) which is an amount of air taken into a cylinder (hereinafter, also referred to as a “fuel injection cylinder”) which is about to carry out its intake stroke, in accordance with a table MapMc(Ga, NE). The in-cylinder intake air amount Mc(k) may be calculated by a well known air amount estimating model (a model constructed in accordance with a physical principle simulating a behavior of the air in the intake air passage).

Step 820: The CPU determines the target air-fuel ratio abyfr(k) based on a formula (16) below. The target air-fuel ratio abyfr(k) is stored in the RAM while being related to (in correspondence with) in the intake stroke of each cylinder. In the formula (16), abyfr0 is a predetermined reference air-fuel ratio, and in the present example, is set at the stoichiometric air-fuel ratio stoich. Accordingly, the target air-fuel ratio abyfr(k) becomes smaller as the sub feedback amount KSFB becomes larger. Note that, the target air-fuel ratio abyfr(k) can further be corrected based on the driving state of the engine 10, such as the intake air amount Ga, the engine rotational speed NE, and the like.

abyfr(k)=abyfr0−KSFB (16)

Step 830: The CPU calculates the pre-correction base fuel injection amount Fbaseb(k) by dividing the above-mentioned in-cylinder intake air amount Mc(k) by the above-mentioned target air-fuel ratio abyfr(k). The pre-correction base fuel injection amount Fbaseb(k) is stored in the RAM while being related to (in correspondence with) the intake stroke of each cylinder.

Next, the CPU proceeds to step 840 to determine whether or not the current driving state satisfies a fuel cut condition. If the fuel cut condition is satisfied, the CPU makes a “Yes” determination at step 840 to directly proceed to step 895, at which the CPU ends the present routine tentatively. Accordingly, since the process of step 870 for performing the fuel injection instruction is not executed, the fuel injection is stopped (the fuel cut operation is carried out).

In contrast, if the fuel cut condition is not satisfied at the determination point in time of step 840, the CPU makes a “No” determination at step 840 to sequentially carry out processes from step 850 to step 870 described below one after another, and thereafter, the CPU proceeds to step 895 to end the present routine tentatively.

Step 850: The CPU reads out the base correction value KF stored in the driving region of the backup RAM to which the current driving state belongs, among the base correction values KF which have been calculated by a routine described later and stored in corresponding driving regions of the backup RAM. Note that, when the main feedback control condition is not satisfied, a value “1” is set in the base correction value KF regardless of the driving state. Further, the CPU sets the post-correction base fuel injection amount Fbase at a value obtained by multiplying the pre-correction base fuel injection amount Fbaseb(k) by the read base correction value KF.

Step 860: The CPU obtains the final fuel injection amount Fi(k) at the present point in time by multiplying the post-correction base fuel injection amount Fbase by the main feedback correction value KFmain which has been obtained by a routine described later, according to the above-mentioned formula (2) and the above-mentioned formula (11).

Step 870: the CPU gives the injection instruction to the fuel injection value 33 corresponding to the fuel injection cylinder so that the fuel of the final fuel injection amount Fi(k) is injected from that fuel injection value 33.

With the above operations, the pre-correction base fuel injection amount Fbaseb(k) is obtained based on the target air-fuel ratio abyfr(k) and the current in-cylinder intake air amount Mc(k), and the post-correction base fuel injection amount Fbase is obtained based on that pre-correction base fuel injection amount Fbaseb(k) and the base correction value KF. Further, the final fuel injection amount Fi(k) is obtained by correcting the post-correction base fuel injection amount Fbase by/with the main feedback correction value KFmain, and the injection instruction of the fuel of that final fuel injection amount Fi(k) is given to the fuel injection value 33 of the fuel injection cylinder.

### <Calculation of Main Feedback Correction Value>

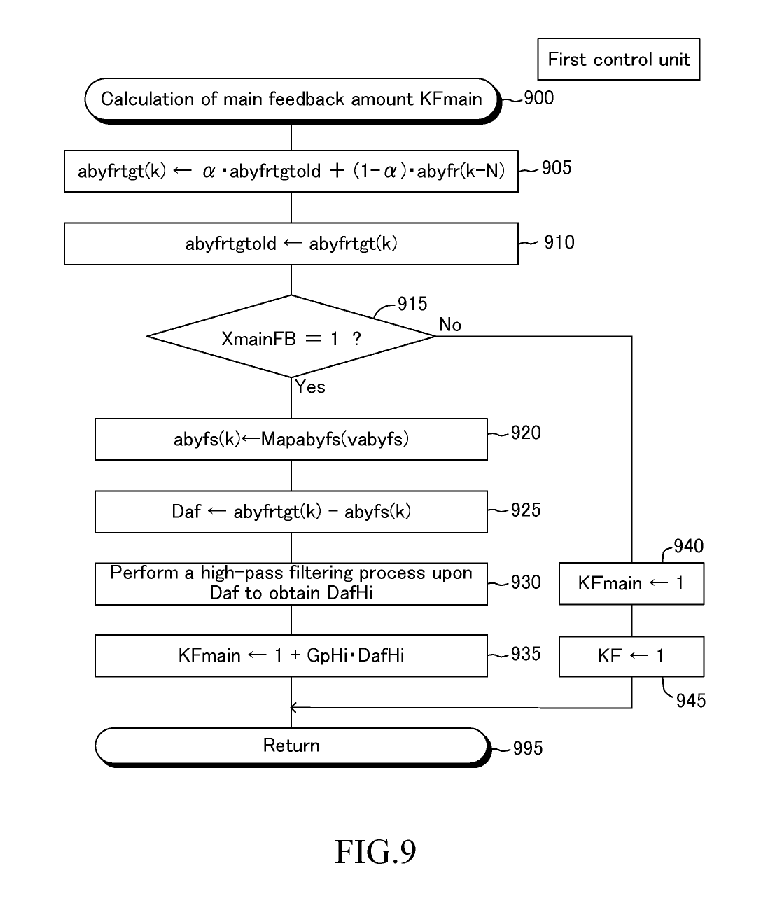

The CPU repeatedly is configured so as to repeatedly carry out a routine shown by a flowchart in FIG. 9 every time an execution period Δt1 (constant time) has elapsed. Accordingly, the CPU starts a process from step 900 at an appropriate timing, and then sequentially carries out processes of step 905 and step 910 described below, to proceed to step 915. Note that, this execution period Δt1 is set to a time duration which is shorter than a time period between two successive injection instructions generated when the engine rotational speed NE is equal to a possible maximum engine rotational speed.

Step 905: The CPU obtains the target air-fuel ratio abyfrtgt(k) for the main feedback control in accordance with a simple low-pass filter formula (abyfrtgt(k)=α·abyfrtgtold+(1−α)·abyfr(k−N)) described at step 905. Here, α is a constant larger than 0 and smaller than 1, and is set in accordance with the time constant τ of the above-mentioned low-pass filter A12. abyfrtgtold is a “target air-fuel ratio abyfrtgt for the main feedback control calculated at step 910 when this routine was previously carried out.” The abyfrtgtold is referred to as a previous target air-fuel ratio for the main feedback control. abyfr(k−N) is the actual upstream target air-fuel ratio N-strokes before the present point in time.

Step 910: The CPU stores the target air-fuel ratio abyfrtgt(k) for the main feedback control calculated at step 905 in the previous target air-fuel ratio abyfrtgtold for the main feedback control, for the next execution of the present routine.

Subsequently, the CPU proceeds to step 915 to determine whether or not a value of a main feedback control condition satisfaction flag XmainFB is “1.” The value of the main feedback control condition satisfaction flag XmainFB is set to “1” when the main feedback control condition is satisfied, while the value of the main feedback control condition satisfaction flag XmainFB is set “0” when the main feedback control condition is not satisfied.

The main feedback control condition is satisfied when all of the following conditions are satisfied, for example.

The upstream air-fuel ratio sensor 56 has been activated.

The fuel cut condition is not satisfied (the current state is not in the fuel-cut driving state).

It is now assumed that the value of the main feedback control condition satisfaction flag XmainFB is “1”, the CPU sequentially carries out processes from step 920 to step 935 described below one after another, and then proceeds to step 995 to end the present routine tentatively.

Step 920: The CPU converts/transforms the output value Vabyfs of the upstream air-fuel ratio sensor 56 at the present point in time based on the table Mapabyfs(vabyfs) shown in FIG. 2 to obtain the currently-detected air-fuel ratio abyfs(k).

Step 925: The CPU subtracts the currently-detected air-fuel ratio abyfs(k) from the target air-fuel ratio abyfrtgt(k) for the main feedback control according to the formula described within step 925 which is the above-mentioned formula (8) to obtain the air-fuel ratio deviation Daf.

Step 930: The CPU performs the high-pass filtering process having the characteristics represented by the above-mentioned formula (9) on the air-fuel ratio deviation Daf to obtain the deviation DafHi for the main feedback control.

Step 935: The CPU adds a value “1” to a product of the the deviation DafHi for the main feedback control and the proportional gain GpHi to obtain the main feedback correction value KFmain.

In contrast, if the value of the main feedback control condition satisfaction flag XmainFB is “0”, the CPU sequentially carries out processes of step 940 and step 945 described below, and proceeds to step 995 to end the present routine tentatively.

Step 940: The CPU sets “1” in the main feedback correction value KFmain.

Step 945: The CPU sets “1” in the base correction value KF.

In this manner, when the main feedback control condition is not satisfied (XmainFB=0), the updating of the main feedback correction value KFmain is stopped, and “1” is set in the value of the main feedback correction value KFmain. Thus, the main feedback control is stopped (the reflection of the main feedback correction value KFmain onto the final fuel injection amount Fi is stopped). Further, when the main feedback control condition is not satisfied (XmainFB=0), since “1” is set in the value of the base correction value KF, the reflection of the base correction value KF onto the final fuel injection amount Fi is stopped.

### <Calculation, Memorization and Storing of Base Correction Value>

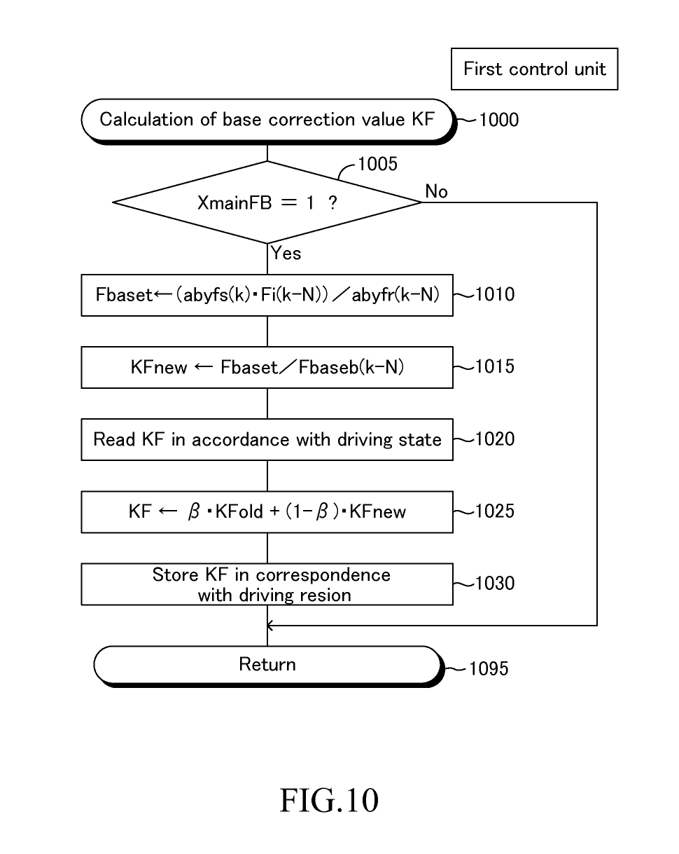

The CPU repeatedly is configured so as to carry out a routine illustrated by a flowchart of FIG. 10 before the execution of the routine shown in FIG. 8. Therefore, the CPU starts a process from step 1000 at an appropriate point in time, to proceed to step 1005, at which the CPU determines whether or not the value of the main feedback control condition satisfaction flag XmainFB is “1.” It is now assumed that the value of the main feedback control condition satisfaction flag XmainFB is “1”, the CPU sequentially carries out processes from step 1010 to step 1030 described below one after another, and the CPU proceeds to step 1095 to end the present routine tentatively.

Step 1010: The CPU calculates the “true base fuel injection amount Fbaset N-strokes before the present point in time” in accordance with the formula described within step 1010 which is the above-mentioned formula (13). Note that the final fuel injection amount Fi(k−N) N-strokes before the present point in time and the target air-fuel ratio abyfr(k−N) N-strokes before the present point in time are both read out from the RAM.

Step 1015: The CPU divides the true base fuel injection amount Fbaset N-strokes before the present point in time by the pre-correction base fuel injection amount Fbaseb(k−N) N-strokes before the present point in time to calculate the current value KFnew (the pre-filtering base correction value KFbf) which is a basis of the base correction value KF, according to the formula described within step 1015 which is the same as the above-mentioned formula (15). Note that the pre-correction base fuel injection amount Fbaseb(k−N) N-strokes before the present point in time is read out from the RAM.

Step 1020: The CPU reads out the base correction value KF from the backup RAM, the base correction value KF being stored in the backup RAM while being related to (in correspondence with) the driving region to which the driving state of the engine 10 belonged N-strokes before the present point in time. The read base correction value KF is the old base correction value KFold.

Step 1025: The CPU calculates the new base correction value KF (final base correction value KF) in accordance with the simple low-pass filtering formula (KF=β·KFold+(1+β)·KFnew) described within step 1025. Here, β is a constant larger than 0 and smaller than 1.

Step 1030: The CPU memorizes and stores the base correction value KF obtained at step 1025 in the storing region of the backup RAM corresponding to the driving region to which the driving state of the engine 10 belonged N-strokes before the present point in time. In this manner, the base correction value KF is updated and stored.

On the one hand, if the value of the main feedback control condition satisfaction flag XmainFB is “0”, the CPU makes a “No” determination at step 1005 to directly proceed to step 1095, at which the CPU ends the present routine tentatively. In this case, no updating process and no memorizing and storing process of the base correction value KF is carried out.

Note that, the value of the base correction value KFnew as it is may be adopted as the new base correction value KF. In this case, step 1020 may be omitted, and the constant β may be set at “0.”

### <Calculation of Sub Feedback Amount>

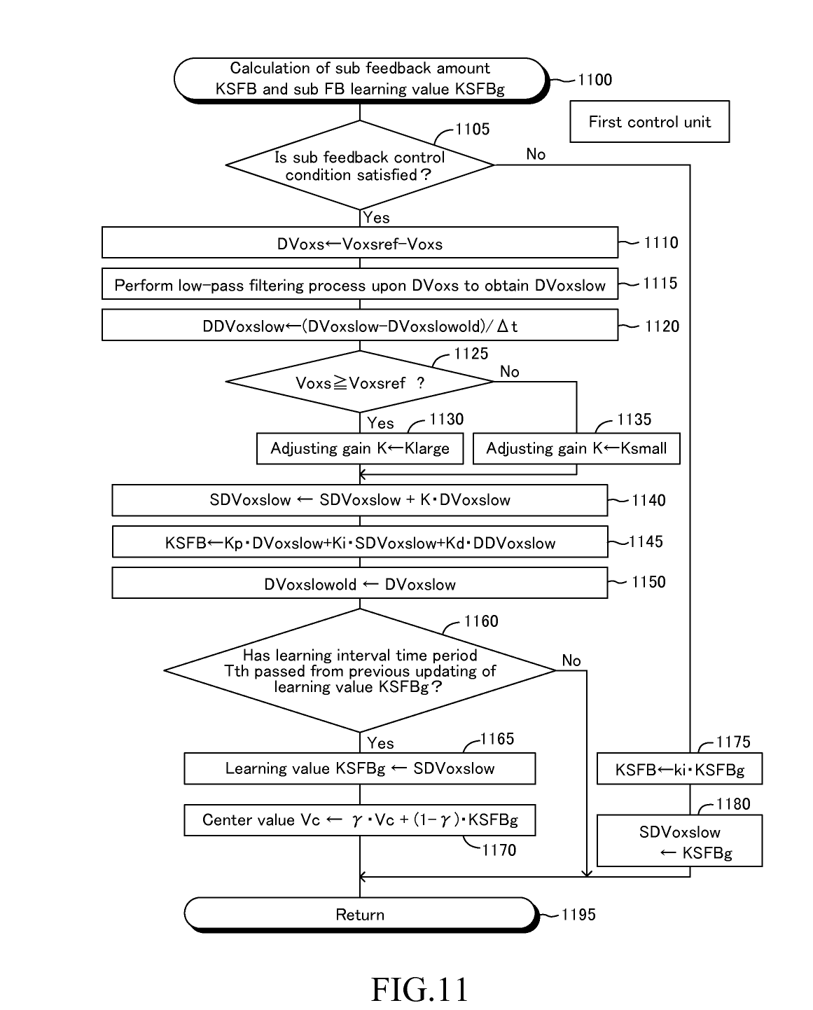

The CPU is configured so as to repeatedly carry out a routine illustrated by a flowchart in FIG. 11 every time a predetermined time period elapses. Therefore, the CPU starts a process at step 1100 at an appropriate point in time, and proceeds to step 1105 to determine whether or not a sub feedback control condition is satisfied. The sub feedback control condition is satisfied, when it is determined that the main feedback control condition is satisfied and the downstream air-fuel ratio sensor 57 has been activated,

The description continues on the assumption that the sub feedback control condition is satisfied. In this case, the CPU sequentially carries out processes from step 1110 to step 1120 one after another to proceed to step 1125.

Step 1110: The CPU obtains the output deviation amount DVoxs by subtracting the output value Voxs of the downstream air-fuel ratio sensor 57 at the present point in time from the downstream target value Voxsref in accordance the formula described within step 1110 which is the above-mentioned formula (3).

Step 1115: The CPU performs the low-pass-filtering process having characteristics represented by the above-mentioned formula (4) on the output deviation amount DVoxs to obtain the post-low-pass-filtered output deviation amount DVoxslow.

Step 1120: The CPU obtains the derivative value DDVoxslow of the post-low-pass-filtered output deviation amount DVoxslow based on a formula (17) described below. In the formula (17), DVoxslowold is a “post-low-pass-filtered output deviation amount DVoxslow set (updated) at step 1150 which will be described later” when the present routine was previously carried out. In addition, Δt is a time period from a point in time at which the present routine was previously carried out to a point in time at which the present routine is currently carried out.

DDVoxslow=(DVoxslow−DVoxslowold)/Δt (17)

Subsequently, the CPU proceeds to step 1125 to determine whether or not the output value Voxs of the air-fuel ratio sensor 57 is equal to or larger than the predetermined downstream target value Voxsref. In the present example, the downstream target value Voxsref is set at a value (for example, 0.7 V) larger than the value Vst (for example, 0.5 V) corresponding to the stoichiometric air-fuel ratio. Note that the downstream target value Voxsref may be set at a value which gradually becomes larger from the value Vst corresponding to the stoichiometric air-fuel ratio, as the intake air amount Ga becomes larger, for example. The downstream target value Voxsref may be changed in accordance with the load of the engine 10, the engine rotational speed NE, a temperature of the upstream catalyst 43, a maximum oxygen storage amount Cmax, and the like, in addition to the intake air amount Ga.

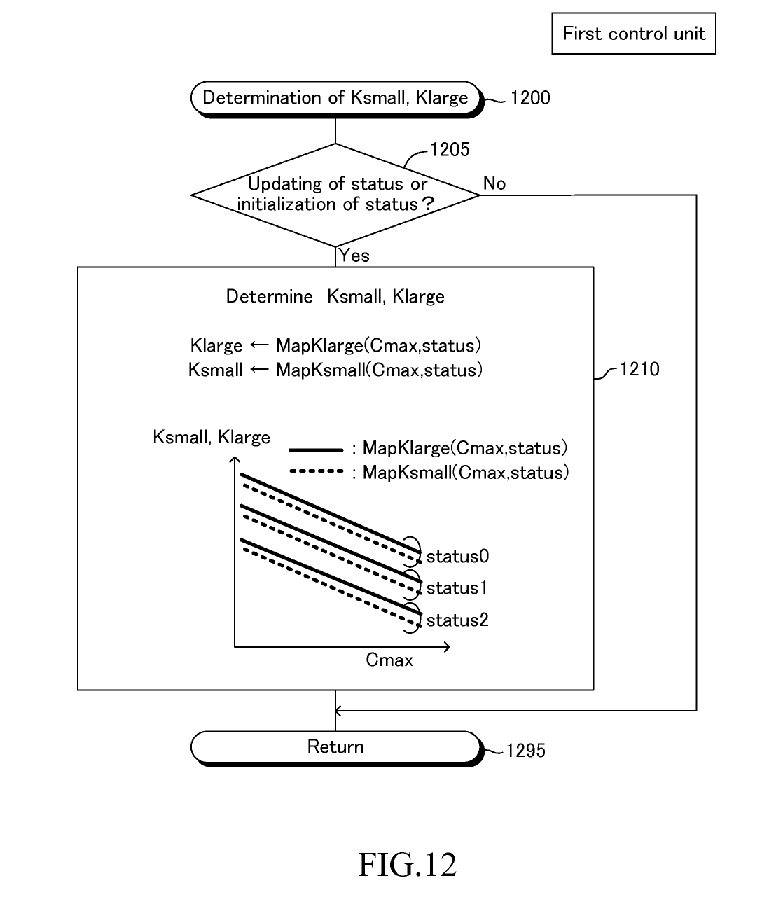

At this time, when the output value Voxs is equal to or larger than the downstream target value Voxsref, the CPU proceeds to step 1130 at which the CPU sets the adjusting gain L to (at) a “large gain Klarge”. In contrast, when the output value Voxs is smaller than the downstream target value Voxsref, the CPU proceeds to step 1135, at which the CPU sets the adjusting gain K to (at) a “small gain Ksmall smaller than the large gain Klarge.” The large gain Klarge and the small gain Ksmall have been determined by a routine shown in FIG. 12 which will be described later.

Subsequently, the CPU sequentially carries out processes from step 1140 to step 1150 one after another to proceed to step 1160.

Step 1140: The CPU obtains a time integral value SDVoxslow in accordance with a formula within step 1140 which is the formula (5).

Step 1145: The CPU obtains the sub feedback amount KSFB in accordance with a formula within step 1145 which is the formula (6).

Step 1150: The CPU stores the post-low-pass-filtered output deviation amount DVoxslow obtained at the above-mentioned step 1110 in the previous value DVoxslowold of the post-low-pass-filtered output deviation amount DVoxslow.

Subsequently, the CPU proceeds to step 1160 to determine whether or not a learning interval time period Tth has passed from a previous updating point in time of the sub FB learning value KSFBg. If the learning interval time period Tth has not elapsed from the previous updating point in time of the sub FB learning value KSFBg, the CPU makes a “No” determination at step 1160 to directly proceed to step 1195, at which the CPU ends the present routine tentatively.

In contrast, if the learning interval time period Tth has elapsed from the previous updating point in time of the sub FB learning value KSFBg when the CPU executes the process of step 1160, the CPU makes a “Yes” determination at step 1160 to proceed to step 1165, at which the CPU stores the time integral value SDVoxslow as the sub FB learning value KSFBg in the backup RAM. In this manner, the CPU fetches in, as the sub FB learning value KSFBg, the “time integral value SDVoxslow which corresponds to a steady component of the sub feedback amount KSFB” at the timing when a time period longer than the updating time period/interval of the sub feedback amount KSFB has elapsed.

Subsequently, the CPU proceeds to step 1170 to update a deviation center (weighted average value) Vc of the past values of the sub FB learning value KSFBg in accordance with a formula (8) below. γ is larger than α and smaller than 1. Vc(n) is the center value Vc after the update, and Vc(n−1) is the center value Vc before the update.

Vc(n)=γ·Vc(n−1)+(1−γ)·KSFBg (18)

In contrast, when the sub feedback control condition is not satisfied at the determination point in time of step 1105, the CPU makes a “No” determination at step 1105 to proceed to step 1175, at which the CPU substitutes a “product of the integral gain Ki and the sub FB learning value KSFBg” into the sub feedback amount KSFB. Subsequently, at step 1180, the CPU sets the sub FB learning value KSFBg in the integral value SDVoxslow, and proceed to step 1195 to end the present routine tentatively.

### <Setting of Adjusting Gain K>

In order to determine “the large gain Klarge and the small gain Ksmall” used as the adjusting gain K, the CPU repeatedly carries out a routine shown by a flowchart in FIG. 12 every time a predetermined time period elapses.

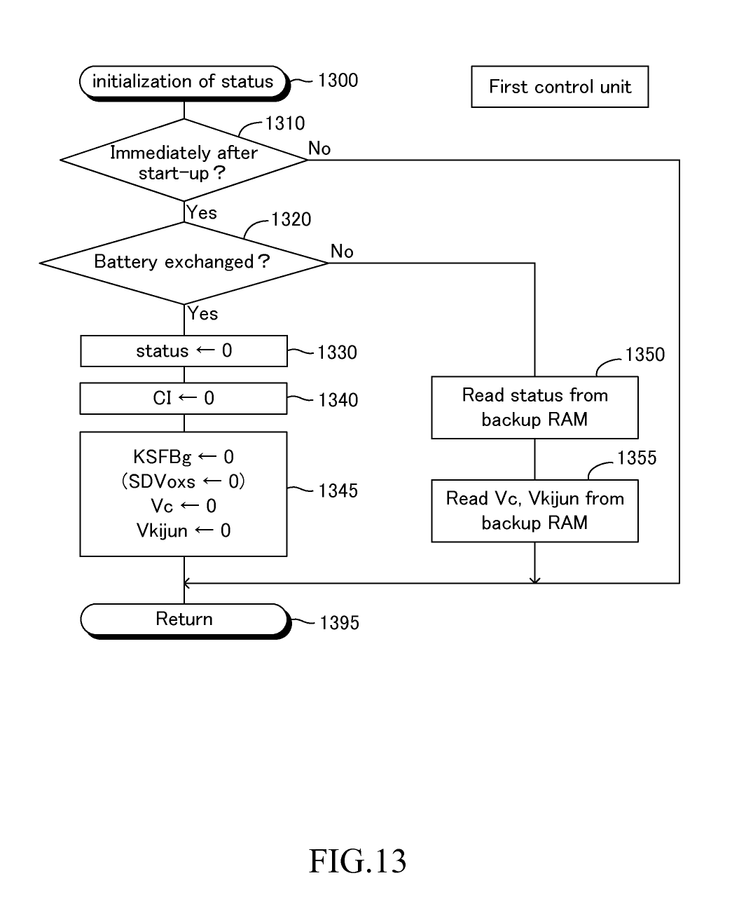

Therefore, at an appropriate point in time, the CPU starts a process at step 1200 of FIG. 12, and proceeds to step 1205 to determine whether or not the present point in time is immediately after the status has been updated. The status is updated by routines illustrated in FIGS. 13 through 16 described later. Note that the update of the status also includes an initialization at step 1330 shown in FIG. 13 described later.

If the present point in time is immediately after the initialization of the status or immediately after the status was updated, the CPU makes a “Yes” determination at step 1205 to proceed to step 1210, at which the CPU determines the large gain Klarge based on a table MapKlarge(Cmax, status) and the small gain Ksmall based on a table MapKsmall(Cmax, status).

As described within step 1210 of FIG. 12, according to the table MapKlarge(Cmax, status), in a case in which the maximum oxygen storage amount Cmax is a certain definite value, the large gain Klarge is determined in such a manner that the large gain Klarge at status 0 is larger than the large gain Klarge at status 1, and the large gain Klarge at status 1 is larger than the large gain Klarge at status 2.

Similarly, according to the table MapKsmall(Cmax, status), in a case in which the maximum oxygen storage amount Cmax is a certain definite value, the small gain Ksmall is determined in such a manner that the small gain Ksmall at status 0 is larger than the small gain Ksmall at status 1, and the small gain Ksmall at status 1 is larger than the small gain Ksmall at status 2.

Further, according to the table MapKlarge(Cmax, status) and the table MapKsmall(Cmax, status), if the value of the maximum oxygen storage amount Cmax is the same and the value of the status is the same, the large gain Klarge and the small gain Ksmall are determined in such a manner that the large gain Klarge is always larger than the small gain Ksmall. In addition, the large gain Klarge and the small gain Ksmall are determined in such a manner that the large gain Klarge and the small gain Ksmall becomes smaller as the maximum oxygen storage amount Cmax becomes larger, in each status.

Note that, the maximum oxygen storage amount Cmax of the upstream catalyst 43 is the maximum value of amount of oxygen the upstream catalyst 43 can store, and is obtained separately by a so-called active air-fuel ratio control. The maximum oxygen storage amount Cmax becomes smaller as the deterioration of the catalyst proceeds. The active air-fuel ratio control is a well-known control described in, for example, Japanese Patent Application Laid-Open (Kokai) No. Hei 5-133264, etc. Therefore, its detailed description is omitted. The maximum oxygen storage amount Cmax is memorized and stored in the backup RAM every time it is obtained.

In contrast, when the CPU carries out the process at step 1205, and if the present point in time is neither immediately after the initialization of the status nor immediately after the updating of the status, the CPU directly proceeds from step 1205 to step 1295 to end the present routine tentatively.

### <Initialization of Status>

There will be next described an operation of the CPU when the CPU initializes the “status” which represents the learning progress degree, and the like. The status N (N=0, 1, 2) is defined as described above.

Hereinafter, for the sake of convenience of the description, it is assumed that the present point in time is immediately after the start of the internal combustion engine 10, and that battery for supplying a power to the electric control unit 70″ has been exchanged. After the start point in time of the internal combustion engine 10, the CPU is configured to carry out a “status initializing routine” as illustrated by a flowchart in FIG. 13 every time a predetermined time period elapses.

Accordingly, when an appropriate point in time comes after the start of the internal combustion engine 10, the CPU starts a process from step 1300 to proceed to step 1310, at which the CPU determines whether or not the “present point in time is immediately after the start point in time of the internal combustion engine 10.”

According to the above-mentioned assumption, the present point in time is immediately after the start of the internal combustion engine 10. Therefore, the CPU makes a “Yes” determination at step 1310 to proceed to step 1320, at which the CPU determines whether or not the “battery for supplying the power to the electric control unit 70” has been exchanged. According to the above-mentioned assumption, the battery has been exchanged beforehand. Therefore, the CPU makes a “Yes” determination at step 1320 to proceed to step 1330, at which the CPU sets and updates the status to “0.” Every time the value of the “status” is updated, the value is memorized/stored in the backup RAM.

Subsequently, the CPU proceeds to step 1340 to clear the counter Cl (set “0” in the counter Cl), and carries out the following processes at step 1345.

The CPU sets “0 (an initial value, a default value)” in the “sub FB learning value KSFBg stored in the backup RAM.”

The CPU sets “0 (an initial value, a default value)” in the time integral value SDVoxslow.

The CPU sets “0 (an initial value, a default value)” in the center value Vc.

The CPU sets “0 (an initial value, a default value)” in the determination reference value Vkijun.

Thereafter, the CPU proceeds to step 1395 to end the present routine tentatively.

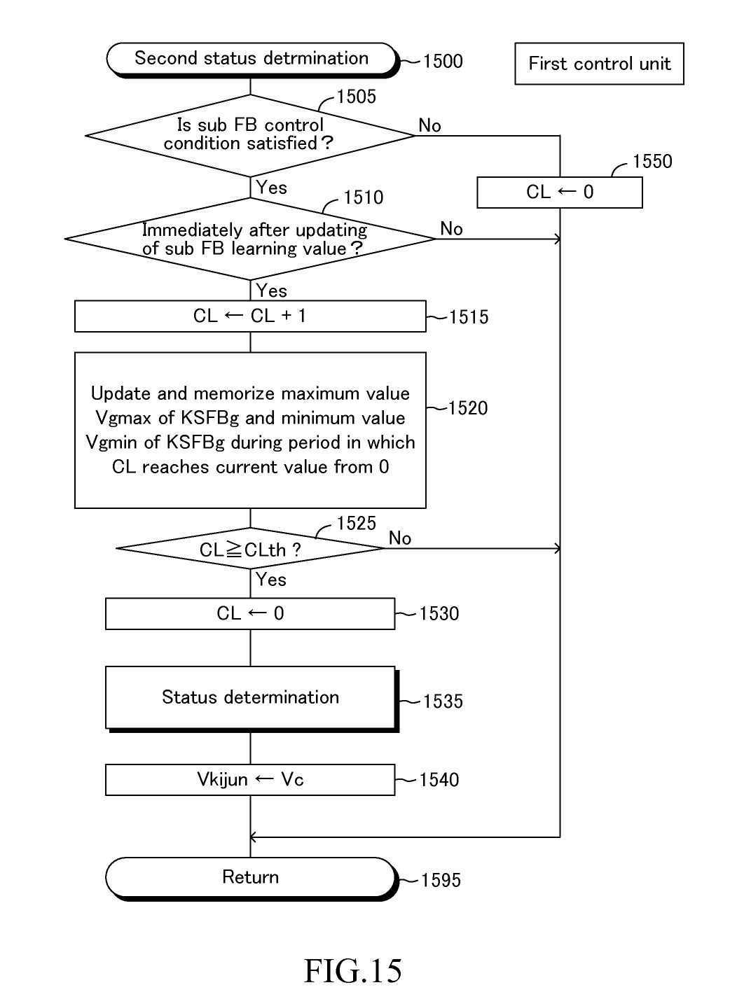

Note that, when the CPU proceeds to step 1320 and determines that the battery has not been exchanged, the CPU makes a “No” determination at step 1320 to proceed to step 1350, at which the CPU reads out the status stored in the backup RAM. Subsequently, the CPU proceeds to step 1355, at which the CPU reads the “center value Vc calculated at step 1170 of FIG. 11” and the “determination reference value Vkijun” from the backup RAM. The determination reference value Vkijun is a reference value for a threshold value which is set for determining the “status”, and is updated at step 1540 of FIG. 15 described later.

Thereafter, the CPU makes a “No” determination at step 1310 to directly proceed to step 1395 to end the present routine tentatively.

### <Determination of Status, Part 1 (First Status Determination)>

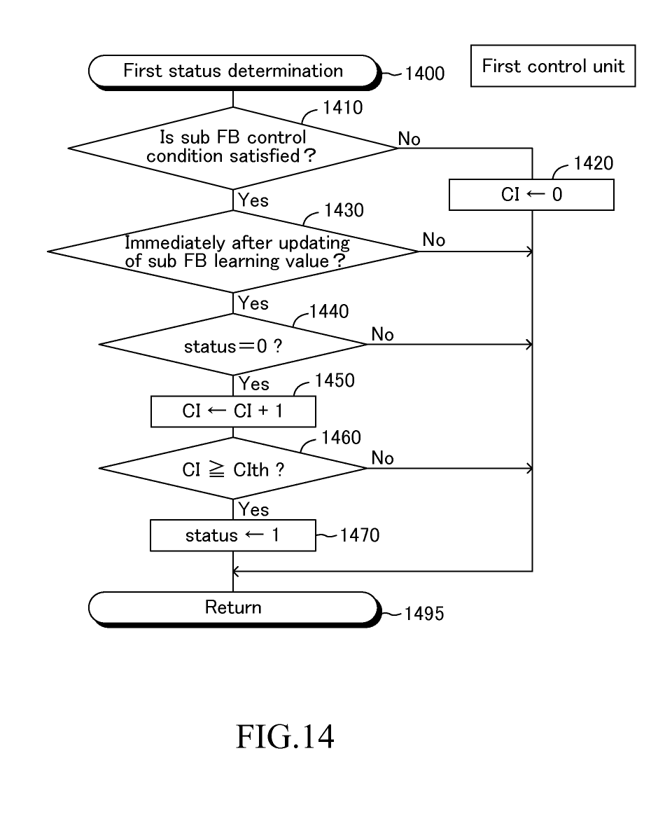

In order to carry out a status determination, the CPU is configured so as to carry out a “first status determination routine” illustrated by a flowchart in FIG. 14 every time a predetermined time period elapses. Therefore, at an appropriate point in time, the CPU starts a process at step 1400 of FIG. 14 to proceed to step 1410, at which the CPU determines whether or not the sub feedback control condition is satisfied.

At this time, if the sub feedback control condition is not satisfied, the CPU makes a “No” determination at step 1410 to proceed to step 1420. Subsequently, the CPU sets “0” in the counter Cl, and then directly proceeds to step 1495 to end the present routine tentatively. Note that “0” is set in the counter Cl by an unillustrated initial routine executed when an unillustrated ignition key switch of the vehicle on which the engine 10 is mounted is changed from an OFF position to an ON position.

In contrast, if the sub feedback control condition is satisfied when the CPU proceeds to step 1410, the CPU makes a “Yes” determination at step 1410 to proceed to step 1430, at which the CPU determines whether or not the present point in time is a “point in time immediately after the sub FB learning value KSFBg was updated” (whether or not the present point in time is immediately after execution of step 1165 and step 1170 of FIG. 11).

At this time, if the present point in time is not the “point in time immediately after the sub FB learning value KSFBg was updated”, the CPU makes a “No” determination at step 1430 to directly proceed to step 1495, at which the CPU ends the present routine tentatively.

In contrast, if the present point in time is the “point in time immediately after the sub FB learning value KSFBg was updated” when the CPU proceeds to step 1430, the CPU makes a “Yes” determination at step 1430 to proceed to step 1440, at which the CPU determines whether or not the status is “0” (the status is status 0). If the status is not “0”, the CPU makes a “No” determination at step 1440 to directly proceed to step 1495, at which the CPU ends the present routine tentatively.

In contrast, if the status is “0” when the CPU proceeds to step 1440, the CPU makes a “Yes” determination at step 1440 to proceed to step 1450, at which the CPU increases/increments the counter Cl by “1.” Thereafter, the CPU proceeds to step 1460 to determine whether or not the counter Cl is equal to or larger than an updating number threshold value Clth. When the counter Cl is smaller than the updating number threshold value Clth, the CPU makes a “No” determination at step 1460 to directly proceed to step 1495, at which the CPU ends the present routine tentatively.

In contrast, if the counter Cl is equal to or larger than the updating number threshold value Clth when the CPU proceeds to step 1460, the CPU makes a “Yes” determination at step 1460 to proceed to step 1470, at which the CPU sets and updates the status to “1” (set the status to be status 1).

In this manner, in the case where the status is “0”, the status is changed to “1” when the number of updating of the sub FB learning value KSFBg becomes equal to or larger than the updating number threshold value Clth. This is because, at the timing when the number of the updating of the sub FB learning value KSFBg becomes equal to or larger than the updating number threshold value Clth, it can be determined that the sub FB learning value KSFBg has come close to the convergent value to some degree. Note that step 1420 can be omitted. Further, “0” can be set in the counter Cl after the execution of step 1470. Furthermore, the routine of FIG. 14 itself can be omitted.

### <Determination of Status Part 2 (Second Status Determination)>

In order to carry out a status determination, the CPU is configured to carry out a “second status determination routine” illustrated by a flowchart in FIG. 15 every time a predetermined time period elapses. It is assumed that the status is set to “0” at step 1330 of FIG. 13 because of the exchange of the “battery for supplying power to the electric control unit 70” before the start of the engine 10, and the sub FB learning value KSFBg is set to “0” at step 1345. Further, it is assumed that the present point in time is immediately after the engine 10 is started.

At an appropriate point in time, the CPU starts a process at step 1500 of FIG. 15 to proceed to step 1505, at which the CPU determines whether or not the sub feedback control condition is satisfied. The sub feedback control condition is generally not satisfied immediately after the engine 10 is started. Accordingly, the CPU makes a “No” determination at step 1505 to proceed to step 1550, at which the CPU sets “0” in a counter CL. Note that “0” is set in the counter CL by the above-mentioned initial routine. Thereafter, the CPU directly proceeds to 1495 to end the present routine tentatively.

In this case, since the CPU proceeds from step 1105 to step 1175 of FIG. 11, the process at step 1165 is not carried out. Therefore, the sub FB learning value KSFBg is held at “0.”

After that, when the engine 10 continues to be driven, the sub feedback control condition becomes satisfied. Thus, the sub feedback amount KSFB is updated by the routine shown in FIG. 11. At this time, since the initialization of the status at step 1330 of FIG. 13 (setting the status to “0”) is carried out, the adjusting gain K is set at either one of “the large gain Klarge and the small gain Ksmall” when the status is “0”, by the routine shown in FIG. 12.

Under such a state, when the CPU proceeds to step 1505 of FIG. 15, the CPU makes a “Yes” determination at step 1505 to proceed to step 1510. Then, at step 1510, the CPU determines whether or not the present point in time is the “point in time immediately after the sub FB learning value KSFBg was updated.” If the present point in time is not the “point in time immediately after the sub FB learning value KSFBg was updated”, the CPU makes a “No” determination at step 1510 to directly proceed to step 1595, at which the CPU ends the present routine tentatively.

In contrast, when the present point in time is the “point in time immediately after the sub FB learning value KSFBg was updated”, the CPU determines makes a “Yes” determination at step 1510 to proceed to step 1515, at which the CPU increases/increments the counter CL by “1.” Subsequently, the CPU proceeds to step 1520 to update a maximum value Vgmax and a minimum value Vgmin of the sub FB learning value KSFBg (in the present example, of the time integral value SDVoxslow). The maximum value Vgmax and the minimum value Vgmin of the sub FB learning value KSFBg are a maximum value and a minimum value of the sub FB learning value KSFBg, respectively, during a time period (a predetermined time period for determining a convergent degree of the sub FB learning value KSFBg) in which the counter CL reach the threshold value CLth used in the next step 1525 from “0.”

Subsequently, the CPU proceeds to step 1525 to determine whether or not the counter CL is equal to or larger than the threshold value CLth. When the counter CL is smaller than the threshold value CLth, the CPU makes a “No” determination at step 1525 to directly proceed to step 1595, at which the CPU end the present routine tentatively.

After that, as the time passes, the process at step 1515 is carried out every time the sub FB learning value KSFBg is updated (that is, every time the learning interval time period Tth elapses). Accordingly, the counter CL reaches the threshold value CLth. In this case, when the CPU proceeds to step 1525, the CPU makes a “Yes” determination at step 15 to proceed to step 1530, at which the CPU sets “0” in the counter CL.

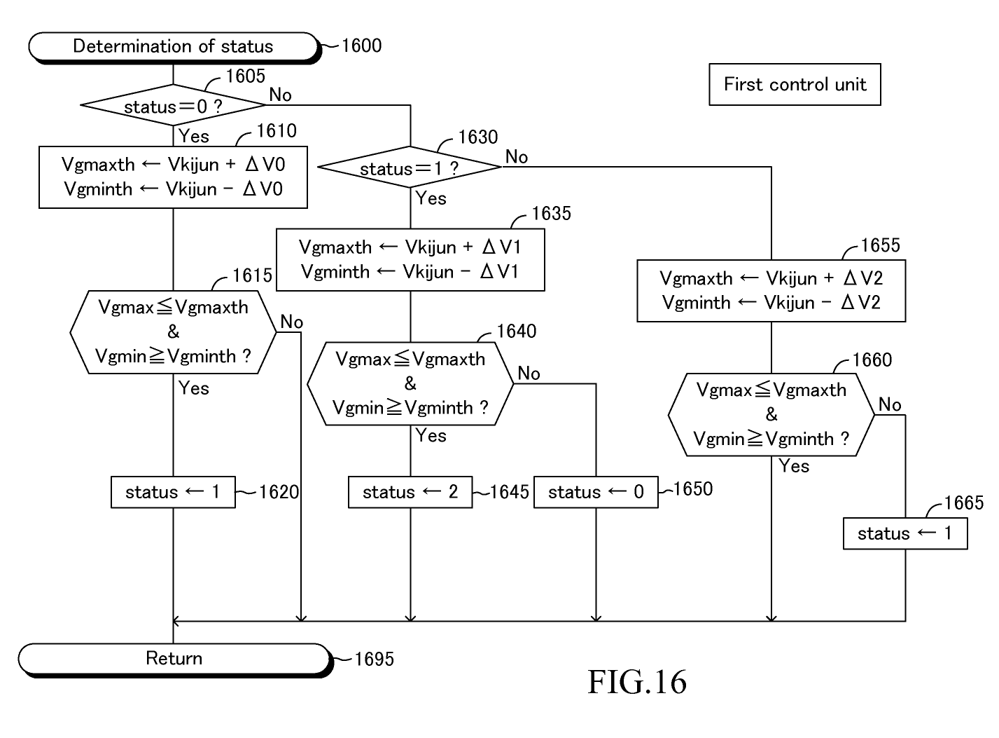

Subsequently, the CPU proceeds to step 1535 to carry out a routine shown in FIG. 16. That is, the CPU starts a process from step 1600 to proceed to step 1605, at which the CPU determines whether or not the status is “0.” According to the above-mentioned assumption, the status is “0”, and thus, the CPU makes a “Yes” determination at step 1605 to proceed to step 1610, at which the CPU sets an upper limit value (a large-side threshold value) Vgmaxth to a value (Vkijun+ΔV0) obtained by adding a “first value ΔV0 which a predetermined positive specific value” to the determination reference value Vkijun. Further, the CPU sets a lower limit value (a small-side threshold value) Vgminth to a value (Vkijun−ΔV0) obtained by subtracting the “first value ΔV0” from the determination reference value Vkijun. Note that the value of the determination reference value Vkijun at this point in time is equal to “0.”

Subsequently, the CPU proceeds to step 1615 to determine whether or not the maximum value Vgmax obtained at step 1520 of FIG. 15 is equal to or smaller than the upper limit value Vgmaxth, and the minimum value Vgmin obtained at step 1520 of FIG. 15 is equal to or larger than the lower limit value Vgminth. That is, the CPU determines whether or not the sub FB learning value KSFBg during a state determination time period (a predetermined time period in which the counter CL reaches the threshold value CLth from 0) has been within a threshold value width defined by the lower limit value Vgminth and the upper limit value Vgmaxth.

In the mean time, according to the above-mentioned assumption, the sub FB learning value KSFBg is set to “0” at step 1345 of FIG. 13, since the battery was exchanged before the start of the engine. In this case, a difference between the sub FB learning value KSFBg and the convergent value SDVoxsfinal is generally large, and the changing speed of the sub feedback amount KSFB and the sub FB learning value KSFBg is therefore large. Accordingly, the maximum value Vgmax is larger than the upper limit value Vgmaxth, or the minimum value Vgmin is smaller than the lower limit value Vgminth.

Consequently, the CPU makes a “No” determination at step 1615 to proceed via step 1695 to step 1540 of FIG. 15, at which the CPU sets the center value Vc in the determination reference value Vkijun. The center value Vc is calculated at step 1170 of FIG. 11. Accordingly, at an execution point in time when the status determination is executed at step 1535, the CPU sets a “weighted average of the sub FB learning value KSFBg (the center value Vc which is a value corresponding to a first-order lag of the value KSFBg) during a time period from a point in time the state determination period (the time period in which the counter CL reach the threshold value Cth from 0) before that execution point in time to that execution point in time” in the “determination reference value Vkijun.” Thereafter, the CPU proceeds to step 1595 to end the present routine tentatively. As a result, the status is held at “0.”

In this state, since the status is “0,” the adjusting gains (the large gain Klarge and the small gain Ksmall) are set the larger values (refer to step 1210 of FIG. 12 and steps 1125 through 1135 of FIG. 11). Thus, (an (absolute value of) a single-time update amount K·DVoxs of (for) the time integral value SDVoxs is set to a large value. That is, the sub feedback amount KSFB and the time integral value SDVoxs (i.e., the sub FB learning value KSFBg) are rapidly changed by means of using the large adjusting gain K. Accordingly, the sub FB learning value KSFBg (the time integral value SDVoxs) is converging (coming closer) from “0 (the initial value, the default value)” to the convergent value SDVoxsfinal at a large changing speed (rate).

As this state continues, the sub FB learning value KSFBg becomes close to the convergent value SDVoxsfinal, and relatively-moderately changes in the vicinity of the convergent value SDVoxsfinal. Consequently, the maximum value Vgmax becomes equal to or smaller than the “upper limit value Vgmaxth calculated at step 1610”, and the minimum value Vgmin becomes equal to or larger than the “lower limit value Vgminth calculated at step 1610.” At this state, when the CPU proceeds to step 1615, the CPU makes a “Yes” determination at step 1615 to proceed to step 1620, at which the CPU sets “1” in the status. Thereafter, the CPU proceeds via step 1695 to step 1540 of FIG. 15.

Note that, even when the condition at step 1615 is not satisfied while the status is “0”, the status is changed to “1” at step 1470, as long as the above-mentioned condition at step 1460 of FIG. 14 (the condition that the counter Cl becomes equal to or larger than the updating number threshold value Clth) is satisfied.

In this manner, the CPU determines the large gain Klarge and the small gain Ksmall based on “the table MapKlarg(Cmax, status) and the table MapKsmall(Cmax, status), respectively, that are related to the status 1, when the CPU proceeds to step 1210 of FIG. 12 in a state where the status is set or updated to “1.”

As a result, the adjusting gains K (the large gain Klarge and the small gain Ksmall) which have been set to the large values are set and changed to the medium values, and thus, the (absolute value of the) single-time updating amount K·DVoxs of the time integral value SDVoxs is set to a medium value. Consequently, the sub FB learning value KSFBg (the time integral value SDVoxs) is further brought close to and converged to the convergent value SDVoxsfinal at a medium changing speed (rate) from the value relatively close to the convergent value SDVoxsfinal.

After this point in time, when the CPU proceeds via step 1535 of FIG. 15 to step 1605 of FIG. 16, since the status is set at “1”, the CPU makes a “No” determination at step 1605. Then, the CPU proceeds to step 1630, at which the CPU determines whether or not the status is “1.” In this case, the CPU makes a “Yes” determination at step 1630 to proceed to step 1635, at which the CPU sets a value (Vkijun+ΔV1) obtained by adding a “second value ΔV1 (ΔV1>0) smaller than the first value ΔV0” to the determination reference value Vkijun in the upper value Vgmaxth. Further, the CPU sets a value (Vkijun−ΔV1) obtained by subtracting the “second value ΔV1” from the determination reference value Vkijun in the lower value Vgminth. Note that the second value ΔV1 is also referred to as a specific value.

Subsequently, the CPU proceeds to step 1640 to determine whether or not the maximum value Vgmax obtained at step 1520 of FIG. 15 is equal to ore smaller than the upper limit value Vgmaxth, and the minimum value Vgmin obtained at step 1520 of FIG. 15 is equal to or larger than the lower limit value Vgminth.

At this time, if the sub FB learning value KSFBg is approaching the convergent value SDVoxsfinal, the maximum value Vgmax is equal to or smaller than the “upper limit value Vgmaxth”, and the minimum value Vgmin is equal to or larger than the “lower limit value Vgminth.” In this case, the CPU makes a “Yes” determination at step 1640 to proceed to step 1645, at which the CPU sets “2” in the status. Thereafter, the CPU proceeds via step 1695 to step 1540 of FIG. 15.

In this manner, the CPU determines the large gain Klarge and the small gain Ksmall based on “the table MapKlarg(Cmax, status) and the table MapKsmall(Cmax, status), respectively, that are related to the status 2, when the CPU proceeds to step 1210 of FIG. 12 in a state where the status is set or updated to “2.”

As a result, the adjusting gains K (the large gain Klarge and the small gain Ksmall) which have been set to the medium values are set and changed to the small values, and thus, the (absolute value of the) single-time updating amount K·DVoxs of the time integral value SDVoxs is further made smaller (decreased).

Therefore, when the status is changed from “1” to 2”, the changing speed of the sub FB learning value KSFBg (the time integral value SDVoxs) becomes smaller than that when the status is “1.” At this stage, the sub FB learning value KSFBg (the time integral value SDVoxs) is sufficiently close to the convergent value SDVoxsfinal. Therefore, the sub FB learning value KSFBg (the time integral value SDVoxs) is stably held/maintained at a value in the vicinity of the convergent value SDVoxsfinal, even when the external disturbance occurs.

On the other hand, after this point in time, when the CPU proceeds via step 1535 of FIG. 15 to step 1605 of FIG. 16, since the status is “2”, the CPU makes a “No” determination at step 1605, and the CPU also makes a “No” determination at step 1630, to proceed to step 1655.

At step 1655, the CPU sets a value (Vkijun+ΔV2) obtained by adding a “third value ΔV2 (ΔV2>0) smaller than the second value ΔV1” to the determination reference value Vkijun in the upper value Vgmaxth. Further, the CPU sets a value (Vkijun−ΔV2) obtained by subtracting the “third value ΔV2” from the determination reference value Vkijun in the lower value Vgminth. Note that the third value Δ2 is also referred to as a specific value.

Next, the CPU proceeds to step 1660 to determine whether or not the maximum value Vgmax obtained at step 1520 of FIG. 15 is equal to or smaller than the upper limit value Vgmaxth, and the minimum value Vgmin obtained at step 1520 of FIG. 15 is equal to or larger than the lower limit value Vgminth.

At this time, if the sub FB learning value KSFBg is stable in the vicinity of the convergent value SDVoxsfinal, the maximum value Vgmax is equal to or smaller than the “upper limit value Vgmaxth”, and the minimum value Vgmin is equal to or larger than the “lower limit value Vgminth.” In this case, the CPU makes a “Yes” determination at step 1660 to proceed to step 1695.

Meanwhile, when the maximum value Vgmax becomes larger than the “upper limit value Vgmaxth which is equal to (Vkijun+ΔV2)” or the minimum value Vgmin becomes smaller than the “lower limit value Vgminth which is equal to (Vkijun−ΔV2)” due to some reasons (for example, the external disturbance such as a change of the misfiring rate or the like, that greatly disturbs the air-fuel ratio), the CPU makes a “No” determination at step 1660 to proceed to step 1665, at which the CPU sets “1” in the status. As a result, the large gain Klarge and the small gain Ksmall become the medium values, so that the updating speed of the sub FB learning value KSFBg is increased.

Further, in a state where “1” is set in the status, when the maximum value Vgmax becomes larger than the “upper limit value Vgmaxth which is equal to (Vkijun+ΔV1)” or the minimum value Vgmin becomes smaller than the “lower limit value Vgminth which is equal to (Vkijun−ΔV1)”, the CPU makes a “No” determination at step 1640 to proceed to step 1659, at which the CPU sets “0” in the status. As a result, the large gain Klarge and the small gain Ksmall become the large values, so that the updating speed of the sub FB learning value KSFBg is further increased.

As described above, the first control unit is the fuel injection amount control apparatus for the internal combustion engine comprising:

a correction amount calculating section (step 1105 through step 1150 of the routine of FIG. 11) configured so as to calculate a time integral value SDVoxslow by accumulating values each obtained by multiplying a deviation DVoxslow between an output value Voxs of a downstream air-fuel ratio sensor 57 and a predetermined downstream target value Voxsref by a predetermined adjusting gain K; so as to calculate, based on the “calculated time integral value SDVoxslow”, an “integral term Ki·SDVoxslow” included in a correction amount (sub feedback amount KSFB) for feedback-correcting an amount of a fuel injected from a fuel injection valve 33 to have the output value Voxs of the downstream air-fuel ratio sensor 57 coincide with the downstream target air-fuel ratio Voxsref; and so as to calculate the correction amount (sub feedback amount KSFB) based on the integral term Ki·SDVoxslow, for a time period where a predetermined downstream feedback condition (sub feedback control condition) is satisfied (refer to the “Yes” determination of FIG. 11);

a learning section (step 1160 and step 1165 of FIG. 11) configured so as to obtain, as a learning value (sub FB learning value KSFBg), a value (i.e., time integral value SDVoxslow) relevant (correlated) to the calculated integral term Ki·SDVoxslow; and

a fuel injection controlling section (step 870 of FIG. 8) configured so as to calculate a final fuel injection amount Fi(k) (particularly, step 820 of the routine of FIG. 8) based on at least the correction amount (sub feedback amount KSFB) when the downstream feedback condition is satisfied, and calculate the final fuel injection amount Fi(k) (particularly, step 820 of routine of FIG. 8, step 1175 of FIG. 11) based on at least the learning value (sub FB learning value KSFBg) when the downstream feedback condition is not satisfied, and so as to have the fuel injection valve 33 inject the fuel of the calculated final fuel injection amount Fi(k).

Further, the learning section is configured so as to determine that the learning value has converged (i.e., a convergence degree of the sub FB learning value KSFBg is improved) when the learning value (sub FB learning value KSFBg) is present between an upper limit value Vgmaxth and a lower limit value Vgminth over a predetermined time period, the upper limit value being a value obtained by adding a positive specific value (any one of a first value ΔV0, a second value ΔV1 and a third value ΔV2) to a determination reference value (determination reference value Vkijun, refer to step 1170 of FIG. 11, step 1540 of FIG. 15) which is a variation center of past values of the learning value calculated based on the past values of the learning value, and the lower limit value being a value obtained by subtracting the specific value from the determination reference value (refer to step 1515 through 1535 of FIG. 15, and, for example, step 1640, step 1660 and step 1615 of the routine of FIG. 16).

In addition, the correction amount calculating section is configured so as to set different values from each other in the adjusting gain K in a case where the learning value is increasing and in the adjusting gain K in a case where the learning value is decreasing, in such a manner that an absolute value of a difference between a magnitude of an increasing speed of the learning value (sub FB learning value KSFBg) and a magnitude of a decreasing speed of the learning value (sub FB learning value KSFBg) (a magnitude of a difference between dV1 and dV2 of FIG. 4) becomes smaller (refer to step 1210 of FIG. 12, and step 1125 through step 1135 of FIG. 11).

According to this configuration, the “magnitude of the changing speed of the learning value in a lean determination period (in a case where the output value Voxs is smaller than the downstream target value Voxsref)” is made closer to the “magnitude of the changing speed of the learning value in a rich determination period (in a case where the output value Voxs is larger than the downstream target value Voxsref).” Accordingly, when the sub FB learning value KSFBg has converged, the sub FB learning value KSFBg is stably present “between the upper limit value Vgmaxth and the lower limit value Vgminth.” As a result, it can be determined with high accuracy that the sub FB learning value KSFBg is converged.

Further, since it is unnecessary to set an excessively large value in the specific value (the first value ΔV0, the second value ΔV1 and the third value ΔV2 for determining the upper limit value Vgmaxth and the lower limit value Vgminth), the convergence degree of the sub FB learning value KSFBg can be determined with high accuracy.

### <Second Embodiment>

A control unit according to a second embodiment of the present invention (hereinafter, also referred to a “second control unit”) will next be described. The second control unit is different from the first control unit only in the two following points.

The first difference point in the second control unit is that an adjusting gain K which determines the magnitude of the changing speed when the sub FB learning value KSFBg (the time integral value SDVoxslow) is increasing is set to a value which is the same as an adjusting gain K which determines the magnitude of the changing speed when the sub FB learning value KSFBg (the time integral value SDVoxslow) is decreasing.

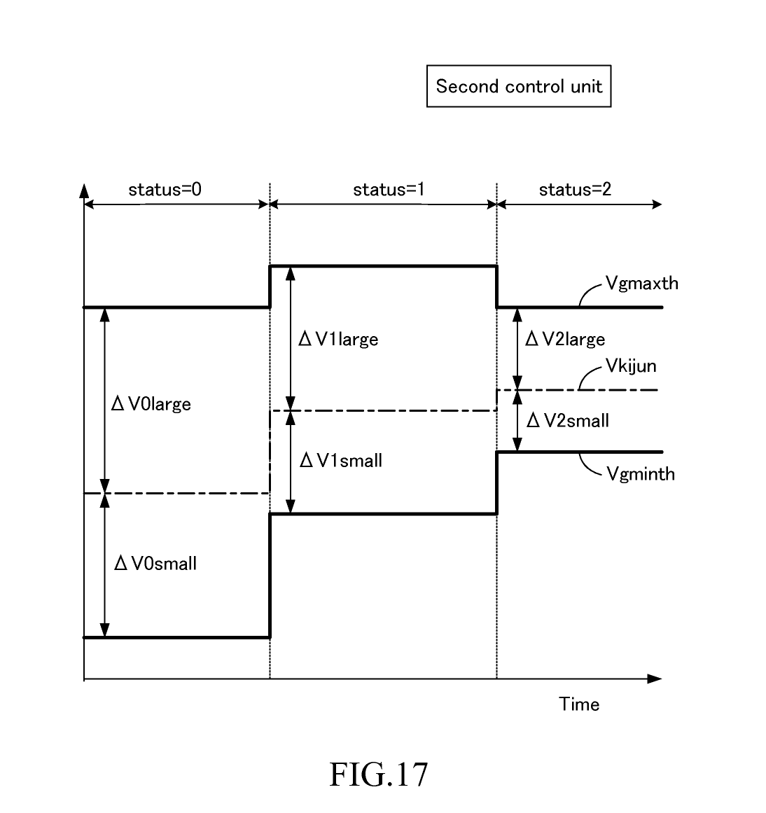

The second difference point in the second control unit is that, as shown in FIG. 17, a specific value which determines the upper limit value Vgmaxth (a first specific value which is a magnitude of a difference between the determination reference value Vkijun and the upper limit value Vgmaxth) is set to a value which is different from a specific value which determines the lower limit value Vgminth (a second specific value which is a magnitude of a difference between the determination reference value Vkijun and the lower limit value Vgminth).

Note that, in the second control unit, the first specific value and the second specific value are set in such a manner that the first specific value is larger than the second specific value. In other words, a difference (the first specific value) between a limit value (the upper value Vgmaxth) on the side where the magnitude of the changing speed of the sub FB learning value KSFBg is large and the determination reference value Vkijun is larger than a difference (the second specific value) between a limit value (the lower value Vgminth) on the side where the magnitude of the changing speed of the sub FB learning value KSFBg is small and the determination reference value Vkijun.

More specifically, in FIG. 17, the first specific value (ΔV0large) in the case of the status 0 is larger than the second specific value (ΔV0small) in the case of the status 0. The first specific value (ΔV1large) in the case of the status 1 is larger than the second specific value (ΔV1small) in the case of the status 1. Further, the first specific value (ΔV2large) in the case of the status 2 is larger than the second specific value (ΔV2small) in the case of the status 2. Note that, the first specific value becomes smaller as the value of the status becomes larger (that is, ΔV0large>ΔV1large>ΔV2large), and the second specific value becomes smaller as the value of the status becomes larger (that is, ΔV0small>ΔV1small>ΔV2small).

### (Actual Operation)

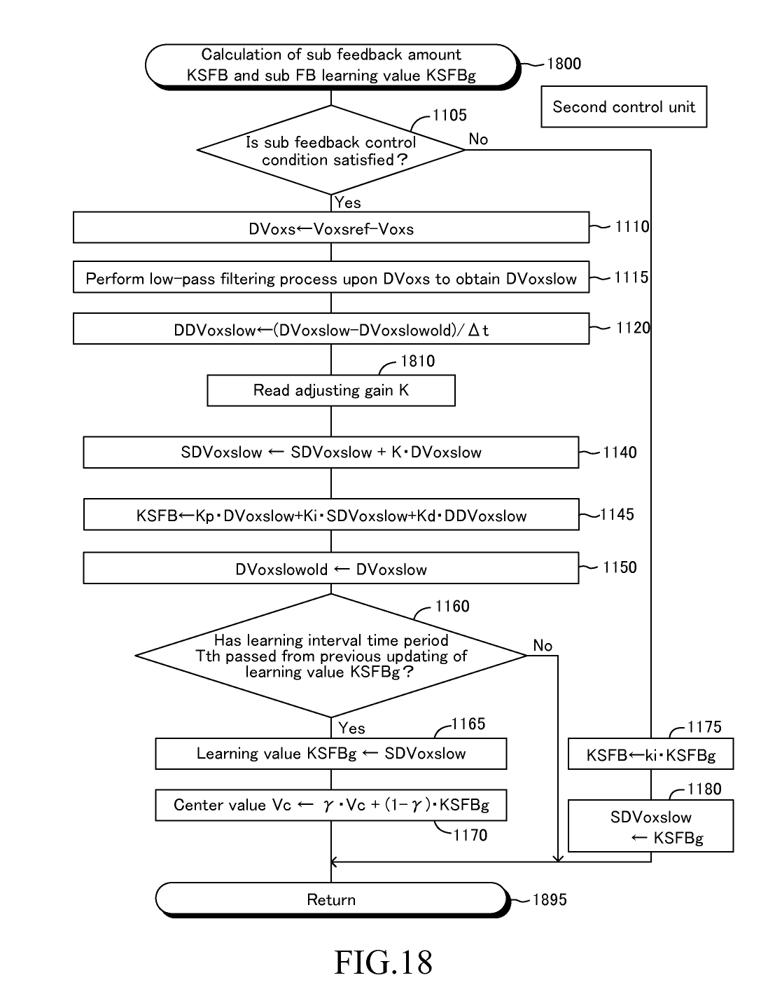

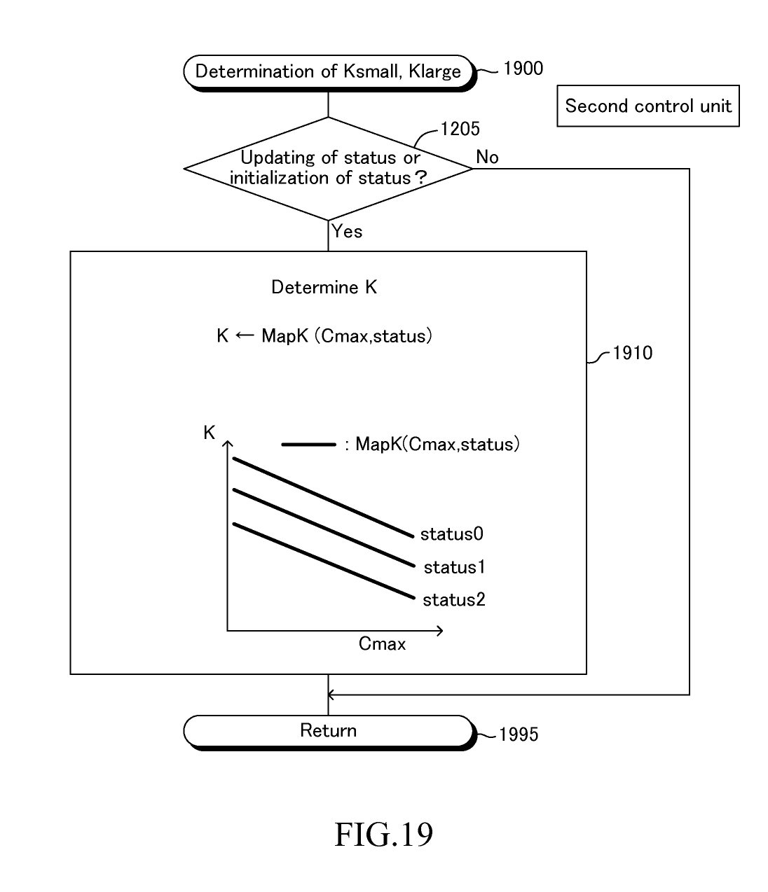

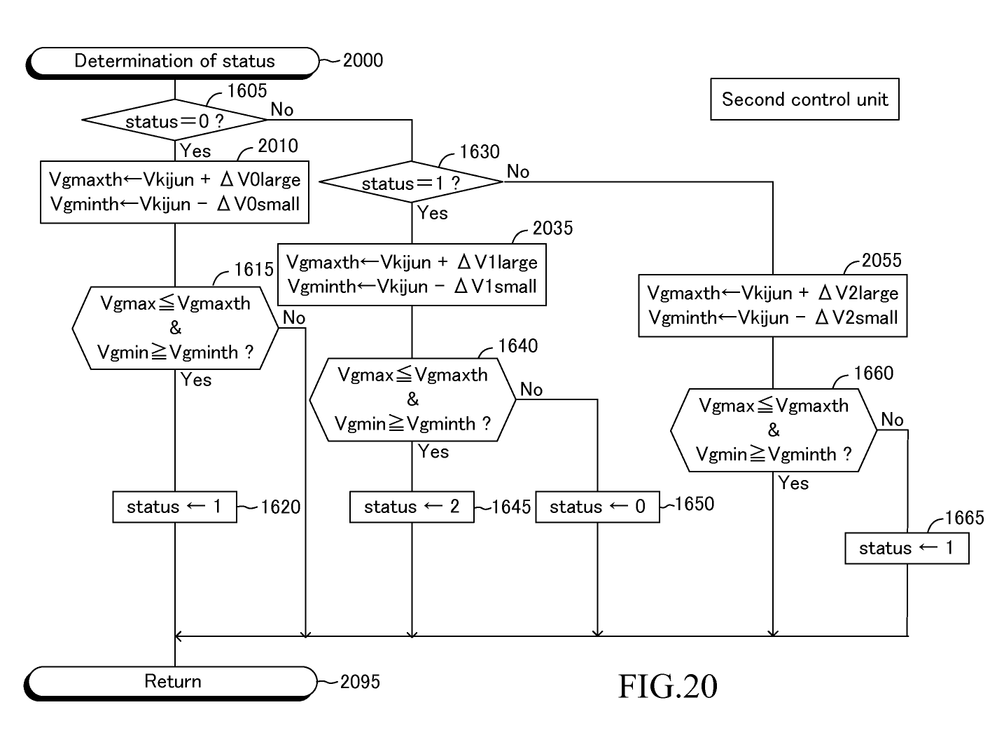

An actual operation of the second control unit will next be described. A CPU of the second control unit carries out the routines illustrated in FIG. 8 through FIG. 10, FIG. 13 through FIG. 15, and FIG. 18 through FIG. 20. FIG. 18 and FIG. 19 are the routines in place of those of FIG. 11 and FIG. 12, respectively. FIG. 20 is a routine in place of that of FIG. 16. The routines illustrated in FIG. 8 through FIG. 10, and FIG. 13 through FIG. 15 have been already described. Therefore, the routines illustrated in FIG. 18 through FIG. 20 will be described below. It should be noted that each step shown in FIG. 18 through FIG. 20 at which the same process is performed as each step which has already been described is given the same numeral/reference as one given to such step.

In order to calculate the sub feedback amount KSFB and the sub FB learning value KSFBg, the CPU of the second control unit repeatedly carries out a routine shown in FIG. 18 every time a predetermined time period elapses. The routine of FIG. 18 is different from the routine shown in FIG. 11 only in that step 1125 through step 1135 of FIG. 11 are replaced by step 1810. Therefore, only this difference point is described below.

The CPU proceeds to step 1810 to read an adjusting gain K. The adjusting gain K has been determined by the routine illustrated in FIG. 19 described later.

The CPU repeatedly carries out the routine shown by a flowchart in FIG. 19 every time a predetermined time period elapses, in order to calculate the adjusting amount K. The routine of FIG. 19 is different from the routine of FIG. 12 only in that step 1210 of the routine of FIG. 12 is replaced by step 1910. Therefore, only this difference point is described below.

If the present point in time is immediately after the initialization of the status or immediately after the updating of the status, the CPU makes a “Yes” determination at step 1205 to proceed to step 1910, at which the CPU determines the adjusting gain K in accordance with a table MapK(Cmax, status).

As described within step 1910 of FIG. 19, according to the table MapK(Cmax, status), in a case in which the maximum oxygen storage amount Cmax is a certain value, the adjusting gain K is determined in such a manner that the adjusting gain K at status 0 is larger than the adjusting gain K at status 1, and the adjusting gain K at status 1 is larger than the adjusting gain K at status 2. Further, according to the table MapK(Cmax, status), the adjusting gain K is determined in such a manner that, the adjusting gain K becomes smaller as the maximum oxygen storage amount Cmax becomes larger, in each status.

Further, when the CPU proceeds to step 1535 of FIG. 15, the CPU is configured to carry out the routine shown in FIG. 20. The routine of FIG. 20 is different from the routine shown in FIG. 16 only in that step 1610, step 1635, and step 1655 of the routine of FIG. 16 are replaced by step 2010, step 2035, and step 2055, respectively. Therefore, only this difference point is described below.

When the status is “0”, the CPU proceeds to step 2010 to set a value (Vkijun+ΔV0large) obtained by adding a “positive predetermined value ΔV0large” to the determination reference value Vkijun in the upper limit value (a large-side threshold value) Vgmaxth. Further, the CPU sets a value (Vkijun−ΔV0small) obtained by subtracting a “positive predetermined value ΔV0small” from the determination reference value Vkijun in the lower limit value (a small-side threshold value) Vgminth. The predetermined value ΔV0large is larger than the predetermined value ΔV0small.

As a result, as illustrated in FIG. 17, the difference (ΔV0large) between the upper limit value Vgmaxth and the determination reference value Vkijun becomes larger than the difference (ΔV0small) between the lower limit value Vgminth and the determination reference value Vkijun.

When the status is “1”, the CPU proceeds to step 2035 to set a value (Vkijun+ΔV1large) obtained by adding a “positive predetermined value ΔV1large” to the determination reference value Vkijun in the upper limit value (the large-side threshold value) Vgmaxth. Further, the CPU sets a value (Vkijun−ΔV1small) obtained by subtracting a “positive predetermined value ΔV1 small” from the determination reference value Vkijun in the lower limit value (the small-side threshold value) Vgminth. The predetermined value ΔV1 large is larger than the predetermined value ΔV1small.

As a result, as illustrated in FIG. 17, the difference (ΔV1large) between the upper limit value Vgmaxth and the determination reference value Vkijun becomes larger than the difference (ΔV1 small) between the lower limit value Vgminth and the determination reference value Vkijun.

When the status is “2”, the CPU proceeds to step 2055 to set a value (Vkijun+ΔV2large) obtained by adding a “positive predetermined value ΔV2large” to the determination reference value Vkijun in the upper limit value (the large-side threshold value) Vgmaxth. Further, the CPU sets a value (Vkijun−ΔV2small) obtained by subtracting a “positive predetermined value ΔV2small” from the determination reference value Vkijun in the lower limit value (the small-side threshold value) Vgminth. The predetermined value ΔV2large is larger than the predetermined value ΔV2small.

As a result, as illustrated in FIG. 17, the difference (ΔV2large) between the upper limit value Vgmaxth and the determination reference value Vkijun becomes larger than the difference (ΔV2small) between the lower limit value Vgminth and the determination reference value Vkijun.

Note that, the predetermined value ΔV0large is larger than the predetermined value ΔV1large, and the predetermined value ΔV1large is larger than the predetermined value ΔV2large. The predetermined value ΔV0large, the predetermined value ΔV1 large, and the predetermined value ΔV2large are generally called “first specific values.” Further, the predetermined value ΔV0small is larger than the predetermined value ΔV1small, and the predetermined value ΔV1small is larger than the predetermined value ΔV2small. The predetermined value ΔV0small, the predetermined value ΔV1small, and the predetermined value ΔV2small are generally called “second specific values.”

As described above, the second control unit comprises:

a correction amount calculating section (step 1105 through step 1150 of the routine of FIG. 11) configured so as to calculate a time integral value SDVoxslow by accumulating values each obtained by multiplying a deviation DVoxslow between an output value Voxs of a downstream air-fuel ratio sensor 57 and a predetermined downstream target value Voxsref by a predetermined adjusting gain K; so as to calculate, based on the “calculated time integral value SDVoxslow”, an “integral term Ki·SDVoxslow” included in a correction amount (sub feedback amount KSFB) for feedback-correcting an amount of a fuel injected from a fuel injection valve 33 to have the output value Voxs of the downstream air-fuel ratio sensor 57 coincide with the downstream target air-fuel ratio Voxsref; and so as to calculate the correction amount (sub feedback amount KSFB) based on the integral term Ki·SDVoxslow;

a learning section (step 1160 and step 1165 of FIG. 11) configured so as to obtain, as a learning value (sub FB learning value KSFBg), a value (i.e., time integral value SDVoxslow) relevant (correlated) to the calculated internal term Ki·SDVoxslow; and

a fuel injection controlling section (step 870 of FIG. 8) configured so as to calculate a final fuel injection amount Fi(k) (particularly, step 820 of the routine of FIG. 8) based on at least the correction amount (sub feedback amount KSFB) when the downstream feedback condition is satisfied, and calculate the final fuel injection amount Fi(k) (particularly, step 820 of routine of FIG. 8, step 1175 of FIG. 11) based on at least the learning value (sub FB learning value KSFBg) when the downstream feedback condition is not satisfied, and so as to have the fuel injection valve 33 inject the fuel of the calculated final fuel injection amount Fi(k).

Further, the learning section in the second control unit is configured so as to determine that the learning value (sub FB learning value KSFBg) has converged (i.e., a convergence degree of the sub FB learning value KSFBg is improved) when the learning value (sub FB learning value KSFBg) is present between an upper limit value Vgmaxth and a lower limit value Vgminth over a predetermined time period, the upper limit value being a value obtained by adding a positive first specific value (e.g., ΔV1large) to a determination reference value which is calculated based on the past values of the learning value, and the lower limit value being a value obtained by subtracting a positive second specific value (e.g., ΔV1small) from the determination reference value (refer to step 2035 and step 1640 of FIG. 20, for example).

In addition, when a magnitude of an increasing speed of the learning value is larger than a magnitude of the decreasing speed of the learning value (the present embodiment corresponds to this case), the learning section sets the first specific value at (to) a value larger than the second specific value. Alternatively, when a magnitude of the decreasing speed of the learning value is larger than a magnitude of the increasing speed of the learning value (for example, when the downstream target value Voxsref is set at (to) a “value smaller than the value Vst corresponding to the stoichiometric air-fuel ratio”), the learning section sets the second specific value at (to) a value larger than the first specific value.

That is, a “threshold value on the side where the magnitude of the changing speed of the learning value (the sub FB learning value KSFBg) is larger (in the present embodiment, the upper limit value Vgmaxth)” among the upper limit value Vgmaxth and the lower limit value Vgminth is a value which more greatly deviates from the determination reference value Vkijun than a “threshold value on the side where the magnitude of the changing speed of the learning value is smaller (in the present embodiment, the lower limit value Vgminth).” Accordingly, when the learning value (the sub FB learning value KSFBg) has converged, the learning value is present “between the upper limit value Vgmaxth and the lower limit value Vgminth”, even if the magnitude of the increasing speed and the magnitude of the decreasing speed of the learning value are different from each other. Consequently, it can be determined with high accuracy that the learning value has converged.

As described above, the fuel injection amount control apparatus according to each of the embodiments of the present invention can determine with high accuracy the convergence degree of the sub FB learning value KSFBg, so that the updating (changing) speed of the sub FB learning value KSFBg can be set to an appropriate value. Therefore, the sub FB learning value KSFBg can be made rapidly come closer to the appropriate value (the value to which the sub FB learning value KSFBg converges), and also, the sub FB learning value KSFBg can be stably maintained in the vicinity of the appropriate value.

Note that the present invention is not limited to be above-mentioned embodiments, but various modifications can be adopted within the scope of the present invention. For example, the sub feedback control may be a well-known configuration where the output value Vabyfs of the upstream air-fuel ratio sensor 56 is corrected by the sub feedback amount. In addition, although the time integral value SDVoxslow in the above-described embodiments is obtained by accumulating values each obtained by multiplying the low-pass-filtered value DVoxslow by the predetermined adjusting gain K, the time integral value SDVoxslow can be obtained by accumulating values each obtained by multiplying the output deviation amount DVoxs which has not been low-pass-filtered by the predetermined adjusting gain K.

Further, the feature of the first control unit (i.e., the adjusting gain K in the case where the changing speed of the sub FB learning value KSFBg is increasing is set to a value different from the adjusting gain K in the case where the changing speed of the sub FB learning value KSFBg is decreasing) and the second control unit (the magnitude of the difference between the upper limit value Vgmaxth and the determination reference value Vkijun is different from the magnitude of the difference between the lower limit value Vgminth and the determination reference value Vkijun) may be both adopted in one control unit. Further, the sub FB learning value KSFBg may be either the integral term Ki·SDVoxslow of the sub feedback amount KSFB or a value obtained by performing a low-pass-filtering on the sub FB learning value KSFBg. That is, the sub FB learning value KSFBg has only to be a value corresponding to the steady component of the sub feedback amount KSFB (a value relevant (correlated) to the integral term of the sub feedback amount KSFB).

1. A fuel injection amount control apparatus for an internal combustion engine comprising:
a fuel injection valve for injecting a fuel into said internal combustion engine;
a downstream air-fuel ratio sensor, disposed downstream of a catalyst which is disposed in an exhaust gas passage of said engine, and outputting an output value corresponding to an air-fuel ratio of a gas flowing out from said catalyst;
a correction amount calculating section configured so as to calculate a time integral value by accumulating values each obtained by multiplying a deviation between said output value of said downstream air-fuel ratio sensor and a predetermined downstream target value by a predetermined adjusting gain, so as to calculate, based on said calculated time integral value, an integral term included in a correction amount for feedback-correcting an amount of said fuel injected from said fuel injection valve to have said output value of said downstream air-fuel ratio sensor coincide with said downstream target air-fuel ratio, and so as to calculate said correction amount based on said integral term, for a time period in which a predetermined downstream feedback condition is satisfied;
a learning section configured so as to obtain, as a learning value, a value correlated to said calculated integral term; and
a fuel injection controlling section configured so as to calculate a final fuel injection amount based on at least said correction amount when said downstream feedback condition is satisfied, calculate said final fuel injection amount based on at least said learning value when said downstream feedback condition is not satisfied, and inject said fuel of said calculated final fuel injection amount from said fuel injection valve,
wherein,
said learning section is configured to determine that said learning value has converged when said learning value is present between an upper limit value and a lower limit value over a predetermined time period, said upper limit value being a value obtained by adding a positive specific value to a determination reference value which is a variation center of past values of said learning value calculated based on said past values of said learning value, and said lower limit value being a value obtained by subtracting said specific value from said determination reference value; and
said correction amount calculating section is configured to set different values from each other in said adjusting gain in a case in which said learning value is increasing and in said adjusting gain in a case in which said learning value is decreasing, in such a manner that an absolute value of a difference between a magnitude of an increasing speed of said learning value and a magnitude of a decreasing speed of said learning value becomes smaller.

2. The fuel injection amount control apparatus according to claim 1, wherein said learning section is configured to set said adjusting gain in such a manner that said adjusting gain in a case in which it is not determined that said learning value has converged is larger than said adjusting gain in a case in which it is determined that said learning value has converged.

3. A fuel injection amount control apparatus for an internal combustion engine comprising:
a fuel injection valve for injecting a fuel into said internal combustion engine;
a downstream air-fuel ratio sensor, disposed downstream of a catalyst which is disposed in an exhaust gas passage of said engine, and outputting an output value corresponding to an air-fuel ratio of a gas flowing out from said catalyst;
a correction amount calculating section configured so as to calculate a time integral value by accumulating values each obtained by multiplying a deviation between said output value of said downstream air-fuel ratio sensor and a predetermined downstream target value by a predetermined adjusting gain, so as to calculate, based on said calculated time integral value, an integral term included in a correction amount for feedback-correcting an amount of said fuel injected from said fuel injection valve to have said output value of said downstream air-fuel ratio sensor coincide with said downstream target air-fuel ratio, and so as to calculate said correction amount based on said integral term, for a time period in which a predetermined downstream feedback condition is satisfied;
a learning section configured so as to obtain, as a learning value, a value correlated to said calculated integral term; and
a fuel injection controlling section configured so as to calculate a final fuel injection amount based on at least said correction amount when said downstream feedback condition is satisfied, calculate said final fuel injection amount based on at least said learning value when said downstream feedback condition is not satisfied, and inject said fuel of said calculated final fuel injection amount from said fuel injection valve,
wherein,
said learning section is configured to determine that said learning value has converged when said learning value is present between an upper limit value and a lower limit value over a predetermined time period, said upper limit value being a value obtained by adding a positive first specific value to a determination reference value which is calculated based on past values of said learning value, and said lower limit value being a value obtained by subtracting a positive second specific value from said determination reference value, wherein,
said learning section is configured to set said first specific value at a value larger than said second specific value when a magnitude of an increasing speed of said learning value is larger than a magnitude of a decreasing speed of said learning value, and to set said second specific value at a value larger than said first specific value when said magnitude of said decreasing speed of said learning value is larger than said magnitude of said increasing speed of said learning value.

4. The fuel injection amount control apparatus according to claim 3, wherein said learning section is configured to set said adjusting gain in such a manner that said adjusting gain in a case in which it is not determined that said learning value has converged is larger than said adjusting gain in a case in which it is determined that said learning value has converged.
